(19) United States
(12) Patent Application Publication
(10) Pub. No.: US 2026/0281417 A1
(43) Pub. Date: Sep. 17, 2026

(54) STORING CROSS-COMPONENT MODELS FOR NON-INTRA CODED BLOCKS

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/472,691

(22) PCT Filed: Aug. 30, 2024
(86) PCT No.: PCT/CN2024/115716

§ 371 Date: Oct. 5, 2025

Related U.S. Application Data
(60) Provisional application No. 63/535,839, filed on Aug. 31, 2023.

(51) Int. Cl. H04N 19/51; H04N 19/105; H04N 19/137; H04N 19/167; H04N 19/172; H04N 19/176; H04N 19/182; H04N 19/186; H04N 19/423

(52) U.S. Cl. CPC H04N 19/51; H04N 19/105; H04N 19/137; H04N 19/172; H04N 19/176; H04N 19/182; H04N 19/186; H04N 19/423; H04N 19/167

(57) ABSTRACT

A video coder receives data to be encoded or decoded as a current block of pixels of a current picture. The current block includes a first-color block and a second-color block. The video coder performs non-intra prediction to generate a reconstruction of the first-color block based on motion information of the current block. The video coder retrieves a cross-component model from an indexed table having table entries storing one or more cross-component models corresponding to different index values. A position in a picture may be used to lookup an index value in an index buffer having buffer entries storing index values corresponding to different positions of the picture. The video coder applies the cross-component model to the reconstruction of the first-color block to generate a prediction of the second-color block. The video coder encodes or decodes the current block by using the prediction of the second-color block.

### CROSS REFERENCE TO RELATED PATENT APPLICATION(S)

The present disclosure is part of a non-provisional application that claims the priority benefit of U.S. Provisional Patent Application No. 63/535,839 filed on 31 Aug. 2023. Content of above-listed application is herein incorporated by reference.

### TECHNICAL FIELD

The present disclosure relates generally to video coding. In particular, the present disclosure relates to methods of coding pixel blocks by cross-component prediction, specifically of non-intra coded blocks.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors (MVs) and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

In advanced motion vector prediction (AMVP) mode, a motion vector predictor (MVP) candidate is determined based on template matching (TM) error to select the one that reaches the minimum difference between the current block template and the reference block template, and then TM is performed only for this particular MVP candidate for MV refinement. The TM process may refine this MVP candidate using iterative search according to an adaptive motion vector resolution (AMVR) mode search pattern. In order to improve the coding performance and/or to reduce complexity for a system using cross-component prediction, methods and apparatus for coding pixel blocks by cross-component prediction are disclosed.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for coding a non-intra coded block using cross-component prediction. A video coder receives data to be encoded or decoded as a current block of pixels of a current picture. The current block includes a first-color block and a second-color block. The video coder performs non-intra prediction to generate a reconstruction of the first-color block based on motion information of the current block. The video coder retrieves a cross-component model from an indexed table having table entries storing one or more cross-component models corresponding to different index values, wherein a position in a picture is used to lookup an index value in an index buffer having buffer entries storing index values corresponding to different positions of the picture, and the index value is used to retrieve the cross-component model. The video coder applies the cross-component model to the reconstruction of the first-color block to generate a prediction of the second-color block. The video coder encodes or decodes the current block by using the prediction of the second-color block.

In some embodiment, the first-color block is for a luma component and the second-color block is for a chroma component. In some embodiments, the first-color block is for a first chroma component (e.g., Cb) and the second-color block is for a second chroma component (e.g., Cr).

The cross-component model may be inherited from a temporal candidate in a list of candidates that includes spatial candidates, non-adjacent candidates, temporal candidates, and/or historical candidates, etc. In some embodiments, the cross-component model may be propagated to a reference block from a further reference block that is located by the motion information of the reference block.

The motion vector may locate a position in a collocated coding tree unit (CTU) row in a further reference picture of a CTU row in which the reference block is located or the motion vector is clipped to locate a position in the collocated CTU row.

In some embodiments, the indexed table stores cross component models for all pictures of the video. In some embodiments, the indexed table is a picture-level table. In some embodiments, the indexed table is associated with one region of a plurality of regions of a picture. In some embodiments, the indexed table is associated with a temporal identifier layer that includes the current picture. In some embodiments, no indexed table is created for pictures in a temporal identifier layer of a largest temporal identifier.

In some embodiments, a buffer entry of the index buffer stores a default index value to indicate that no cross-component model is available for a corresponding position in the picture. When a cross-component model is deleted from the indexed table, each buffer entry of the index buffer having an index value that indicates the deleted cross-component model is reset to the default index value, and each index value in the index buffer that is greater than the index value that indicates the deleted cross-component model is decreased by one. When a cross-component model is to be added to the indexed table for a position in a picture, if the to-be-added cross-component model is sufficiently similar to an existing cross-component model already stored in the indexed table, the to-be-added cross-component model is not added to the indexed table and an index value used to indicate the existing cross-component model is stored in a buffer entry of the index buffer that correspond to the position.

In some embodiments, the indexed table has a maximum size limit. In some embodiments, when the indexed table reaches a maximum size limit upon storing a new cross-component model into the indexed table, an earliest stored cross-component model is deleted from the indexed table to free up space for the new cross-component model. In some embodiments, when the indexed table reaches a maximum size limit upon storing a new cross-component model into the indexed table, the new cross-component model is not stored into the indexed table. The maximum size limit that may be determined based on whether the picture is an inter frame or an intra frame, or based on a temporal identifier of the picture, or based on a picture order count (POC) distance between the picture and a closest previously coded intra frame.

In some embodiments, when no cross-component model is available for the first position in the first indexed table, a cross-component model is copied from a second indexed table associated with a reference picture to the first indexed table (the reference picture may be located by the motion information), or a block vector is used to locate a second position in the picture and an index value is copied from a buffer entry for the second position to a buffer entry for the first position. In some embodiments, the indexed table is reset when the video coder is encoding or decoding an Instantaneous Decoding Refresh (IDR) or Clear Random Access (CRA) picture.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates gradient filters enabled for Gradient Linear Model (GLM).

FIG. 2 illustrates a 3×2 filter using non-down-sampled luma samples as inputs.

FIG. 3 illustrates reconstruction of component samples using cross-component residual model (CCRM).

FIG. 4 illustrates positions of spatial merge candidates.

FIG. 5 shows a pattern of adjacent and non-adjacent spatial merge candidates.

FIG. 6 illustrates the scaling of motion vector for a temporal merge candidate.

FIG. 7, which shows candidate positions for temporal merge candidates C₀ and C₁.

FIGS. 8A-B illustrate a current block and its non-adjacent spatial neighboring blocks.

FIG. 9 illustrates propagation of cross-component model (CCM) based on block vectors.

FIG. 10 illustrates a current block having two block vectors identifying two reference blocks and that both have CCM information.

FIG. 11 illustrates examples of CCM information propagation based on motion vectors.

FIG. 12 illustrates a current block having two motion vectors identifying two reference blocks and that both have CCM information.

FIG. 13 illustrates a position located by the motion vector in a reference picture.

FIG. 14 conceptually illustrates a picture level index buffer for storing indices of a CCM information storage table.

FIG. 15 illustrates copying CCM information from the indexed table of a collocated picture to the indexed table of the current picture.

FIG. 16 conceptually illustrates deriving and storing CCM information by copying entries of an index buffer based on block vectors.

FIG. 17 illustrates deriving and storing CCM information by copying and storing entries of indexed tables based on motion vectors.

FIG. 18 illustrates an example pattern of n taps in a window region M×N.

FIG. 19 illustrates an example pattern of m taps in a window region M2×N2.

FIG. 20 illustrates the spatial neighboring region of a current block that may serve as the reference region.

FIG. 21 illustrates an example video encoder that may implement cross-component prediction.

FIG. 22 illustrates portions of the video encoder that implement cross-component prediction for non-intra coded blocks.

FIG. 23 conceptually illustrates a process for encoding a non-intra coded block by using cross-component prediction.

FIG. 24 illustrates an example video decoder that may implement cross-component prediction.

FIG. 25 illustrates portions of the video decoder that implement cross-component prediction for non-intra coded blocks.

FIG. 26 conceptually illustrates a process for decoding a non-intra coded block by using cross-component prediction.

FIG. 27 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Cross-Component Models

a. Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β$$

where pred_{C}(i, j) represents the predicted chroma samples in a CU and rec_{L}(i, j) represents the downsampled reconstructed luma samples of the same CU. The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied;

In this disclosure, the term {LM_LA, LM_A, LM_L} and {CCLM_LT, CCLM_T, CCLM_L} are used interchangeably.

b. Multiple Model CCLM

Multiple model CCLM mode (MMLM) is for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′_{L}[x, y]≤Threshold is classified into group 1; while a neighbouring sample with Rec′_{L}[x, y]>Threshold is classified into group 2. Specifically:

$${Pred}_{C} ( i , j ) = {α}_{1} \times {Rec}_{L}^{′} [ x , y ] + {β}_{1} if {Rec}_{L}^{′} [ x , y ] \leq Threshold$$

$${Pred}_{C} ( i , j ) = {α}_{2} \times {Rec}_{L}^{′} [ x , y ] + {β}_{2} if {Rec}_{L}^{′} [ x , y ] > Threshold$$

In this disclosure, the term {MMLM_LA, MMLM_A} and {MMLM_LT, MMLM_T} are used interchangeably.

c. Convolutional Cross-Component Model (CCCM)

In CCCM, a convolutional model is applied to cross-component prediction. The convolutional model has 7-tap filter consisting of a 5-tap plus sign shape spatial component, a nonlinear term (P) and a bias term (B). The input to the spatial 5-tap component of the filter includes a center (C) luma sample (which is collocated with the chroma sample to be predicted) and the center luma sample's above/north (N), below/south (S), left/west (W) and right/east (E) neighbors. Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients are calculated by minimising MSE between predicted and reconstructed chroma samples in the reference area.

d. Gradient Linear Model (GLM)

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G.

$$C = α \cdot G + β$$

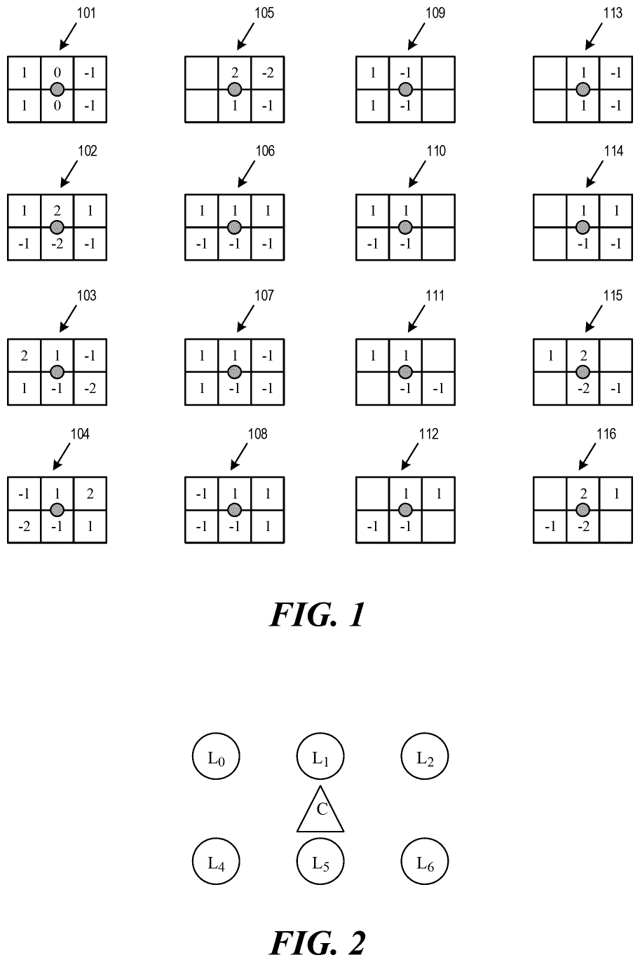

FIG. 1 illustrates gradient filters enabled for Gradient Linear Model (GLM), specifically, the figure illustrates 16 Sobel based gradient patterns 101-116 for GLM. The gray dot in the middle of each gradient pattern represents the chroma position (C).

e. CCCM Using Non-Downsampled Luma Samples

For some embodiments, CCCM mode with 3×2 filter using non-downsampled luma samples may be used. The filter consists of 6-tap spatial terms, four nonlinear terms and a bias term. FIG. 2 illustrates a 3×2 filter using non-downsampled luma samples as inputs. The 6-tap spatial terms correspond to 6 neighboring luma samples (i.e., L0, L1, . . . , L5) around the chroma sample (i.e., C) to be predicted, the four non-linear terms are derived from the samples L0, L1, L2, and L3 according to:

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) ≫ bitDepth ) + {α}_{10} \cdot β + offsetChroma$$

f. Cross-Component Residual Model (CCRM)

Cross-component residual model (CCRM) may be applied to predict chroma samples from reconstructed luma samples when the block uses inter prediction or intra block copy (IBC, which refers to coding pixel blocks by referencing pixel positions within same current picture as the current block by using block vectors.)

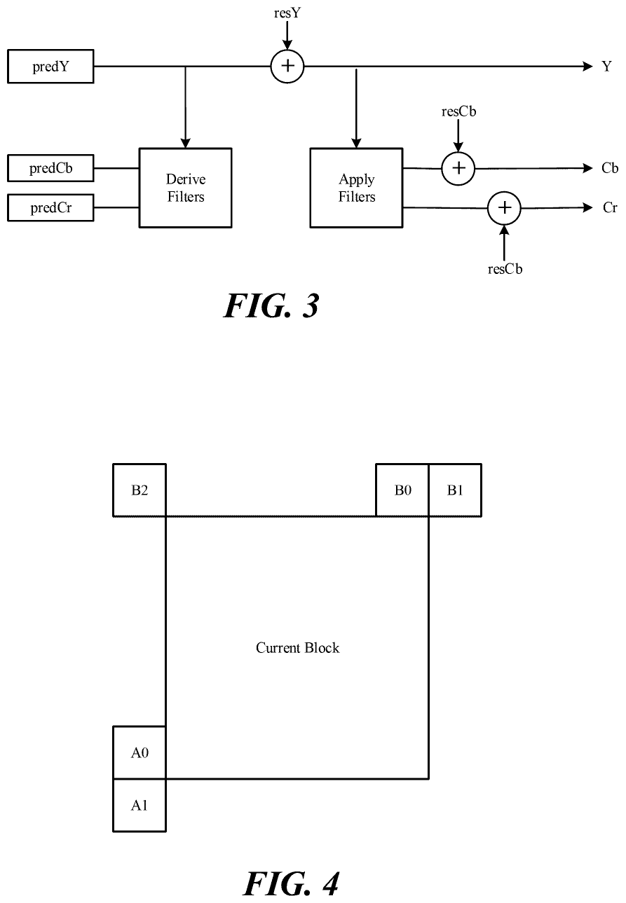

FIG. 3 illustrates reconstruction of component samples using cross-component residual model (CCRM). The figure illustrates the decoder side of the method. The cross-component filters are derived using the prediction signals of luma and chroma. The derived filters are applied to the reconstructed luma signal producing the final chroma predictions.

### II. Current Picture Referencing

a. Intra Block Copy (IBC)

Intra block copy (IBC) or current picture referencing (CPR) refer to coding pixel blocks by referencing pixel positions within same current picture as the current block by using block vectors. A block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU may be treated as a third prediction mode other than intra or inter prediction modes. The IBC mode is applicable to the CUs with both width and height smaller than or equal to 64 luma samples.

b. Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### III. Merge Prediction

For each inter-predicted CU, motion parameters may include motion vectors, reference picture indices and reference picture list usage index, and additional information needed for the certain coding features to be used for inter-predicted sample generation. A merge mode is specified whereby the motion parameters for the current CU are obtained from neighbouring CUs, including spatial and temporal candidates. The merge mode can be applied to any inter-predicted CU, not only for skip mode. In some embodiments, a merge candidate list is constructed by including the following types of candidates:
Spatial MVP from spatial neighbour CUs
Temporal MVP from collocated CUs
History-based MVP from a FIFO table
Pairwise average MVP
Zero MVs.
   a. Spatial Candidates Derivation

For derivation of spatial merge candidates, a maximum of four merge candidates are selected among candidates located in the positions. FIG. 4 illustrates positions of spatial merge candidates. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₀ is added, the addition of the remaining candidates is subject to a redundancy check which ensures that candidates with same motion information are excluded from the list so that coding efficiency is improved.

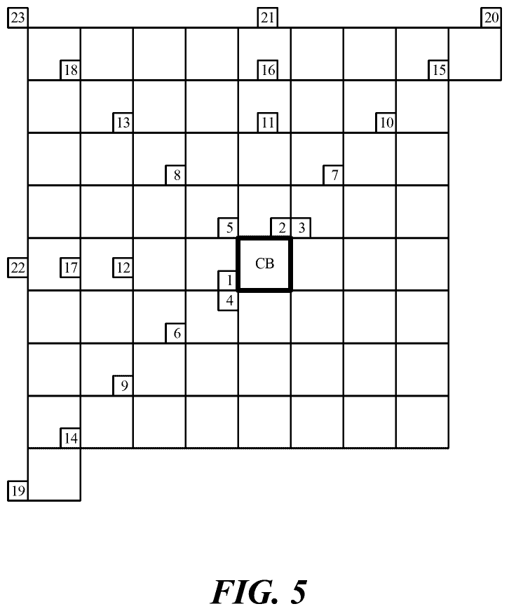

In addition to the above-mentioned spatial candidates, non-adjacent spatial merge candidates may be inserted after the TMVP in the regular merge candidate list. FIG. 5 shows a pattern of adjacent and non-adjacent spatial merge candidates. The distances between non-adjacent spatial candidates and current coding block are based on the width and height of current coding block.

b. Temporal Candidate Derivation

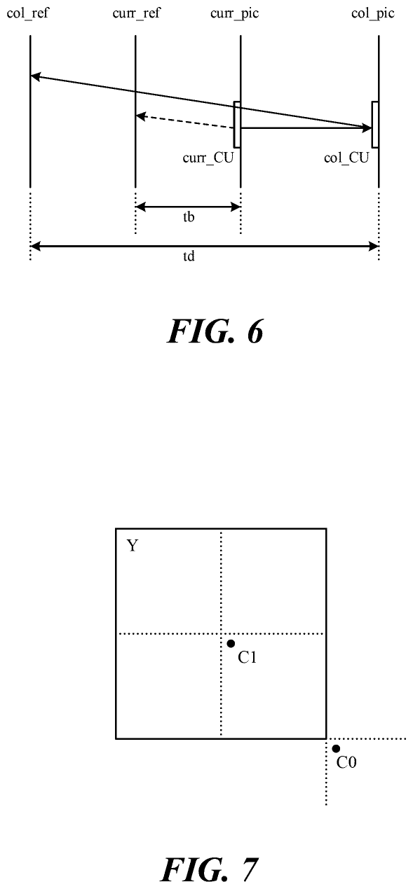

In some embodiments, only one temporal merge candidate is added to the merge list. Particularly, in the derivation of this temporal merge candidate, a scaled motion vector is derived based on co-located CU belonging to the collocated reference picture. The reference picture list and the reference index to be used for derivation of the co-located CU is explicitly signaled in the slice header. FIG. 6 illustrates the scaling of motion vector for a temporal merge candidate. Specifically, the motion vector of the temporal merge candidate for the current block (curr_CU) is obtained from scaling the motion vector of a co-located CU (col_CU) in a collocated picture (col_pic) using the POC distances, tb and td, where tb is defined to be the POC difference between the reference picture of the current picture (curr_ref) and the current picture (curr_pic) and td is defined to be the POC difference between the reference picture of the co-located picture (col_ref) and the co-located picture (col_pic). The reference picture index of temporal merge candidate is set equal to zero.

The position for the temporal candidate is selected between candidates C₀ and C₁, as depicted in FIG. 7, which shows candidate positions for temporal merge candidates C₀ and C₁. If CU at position C₀ is not available, is intra coded, or is outside of the current row of CTUs, position C₁ is used. Otherwise, position C₀ is used in the derivation of the temporal merge candidate.

c. History-based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

d. Pair-wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs may be inserted in the end until the maximum merge candidate number is encountered.

### IV. Cross-Component Prediction for Non-Intra Coded Blocks

In some embodiments, the cross-component information is used to improve prediction accuracy of an inter block (a block that is coded by inter-prediction) or a non-intra block (a block that is not coded by intra-prediction). The luma information from the corresponding luma component of the current chroma block and/or the chroma information from the current chroma block and/or the chroma information from the previous coded chroma component may be used to improve the prediction accuracy of the chroma component of the inter block or the non-intra block.

In some embodiments, for a coding unit (under single tree splitting) including luma (Y) and chroma (Cb and/or Cr) components, the prediction for Cb and/or Cr is improved by applying the cross-component models to information (current reconstructed or predicted) from Y (first scheme). In some embodiments, the prediction for Cr is improved by applying the cross-component models to information (current reconstructed or predicted) from Cb (second scheme).

When the selected model information refers to traditional cross-component linear model(s), the proposed method is called as inter cross-component linear model (inter CCLM) mode. When the selected model information refers to convolutional cross-component model(s) derived by a regression-based method (as CCCM for example), the proposed method is called as inter cross-component convolution model (inter CCCM) mode.

In some embodiments, an inherited cross-component mode may be used for the current chroma block with the following steps: (i) building a candidate list (modelList) for the current block where the candidate list includes cross-component models; (ii) selecting one or more model information in the list; and (iii) using the model information to generate one or more hypotheses of predictions for the current chroma component (Cb or Cr) by applying and/or modifying the selected model information to the reconstructed or predicted samples for the corresponding luma component (Y) or reconstructed corresponding chroma component (Cb).

In some embodiments, a self-derived cross-component mode is added into the above-mentioned candidate list (i.e., modelList). (Self-derived mode is also referred to as re-derived mode, in which reconstructed samples or neighboring samples of the selected candidate block are fetched to derive the cross-component model.) In some embodiments, the self-derived cross-component mode is not added into the list and a selection of using the proposed inherited mode and/or using the proposed self-derived mode is designed. In some embodiments, the selection of using the inherited model and/or using the self-derived model is determined following an explicit rule, or an implicit rule, or both. More details are described in Section IV.e.

a. Storage and Inheritance of the Model

In some embodiments, when the current inter or non-intra block uses the model parameters from a self-derived cross-component model, the used model parameters can be saved and/or referenced by one or more subsequent or following coding block. For example, if the self-derived cross-component model is CCRM, all or any subset of the model parameters can be saved. In some embodiments, when the current inter block uses an inherited cross-component mode, the used model parameters can be saved and/or referenced by one or more subsequent or following coding block. For example, if the inherited cross-component model is CCCM, all or any subset of the model parameters can be saved.

In some embodiments, if the subsequent coding block is intra, it is allowed to use the saved model parameters. In some embodiments, if the subsequent coding block is coded by inter or current picture referencing (e.g., IBC) or any other mode-type, the coding block is allowed to use the saved model parameters. In some embodiments, if the subsequent coding block and the current block have different mode-types (e.g., the subsequent block is an inter block and the current block is not an inter block), the subsequent coding block is not allowed to use the saved model parameters.

In some embodiments, when the current inter block uses any cross-component models (e.g., the inherited cross-component model, the self-derived cross-component model, cross-component model used in chroma fusion which means the chroma prediction is based on adding one or more hypotheses of cross-component prediction to one or more existing hypotheses of prediction of non-cross-component prediction), or any combination of the above, the used model parameters can be saved and/or referenced by the following coding blocks. For example, if the cross-component model is an inherited CCCM model, all or any subset of the model parameters can be saved. In some embodiments, if the subsequent coding block is intra, it is allowed to use the saved model parameters. If the subsequent coding block is inter or another mode-type (e.g., IBC), the subsequent coding block is allowed to use the saved model parameters. In some embodiments, if the subsequent coding block has a different mode-type (e.g., not an inter block) than the current block, the subsequent coding block is not allowed to use the saved model parameters.

b. Building a Candidate List that Includes Cross-Component Models

In some embodiments, when building a merge-like candidate model list (modelList), one or more of the following candidate model information are included in the candidate list. Each candidate in the candidate list corresponds to one candidate model information. More details about the definition of the model information can be found in the section V.a “Inherit Cross-Component Model (CCM) information”. Examples of model information includes:
Spatial model information from spatial neighbour blocks (corresponding to “Spatial MVP from spatial neighbour CUs” for inter),
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In some embodiments, a pre-defined condition is used to determine whether a particular candidate in the candidate list is a valid or available candidate for providing model information. The pre-defined condition may be different for different candidate types. For example, when a candidate used to provide spatial model information (e.g., the candidate type=spatial neighbor), the candidate considered valid if it is from one of the spatial adjacent and non-adjacent neighbors (or any subset of the blocks in a neighboring search region for the current block) that satisfies a pre-defined condition. For another example, when the candidate type is of non-adjacent neighbors, the pre-defined condition may require that the non-adjacent neighbor candidate is in a predefined “available” region of non-adjacent spatial candidates.

For another example, the pre-defined condition may specify that the candidate is valid only if the candidate is a neighbor that is coded by a cross-component mode or by combining with a cross-component mode. The cross-component mode refers to modes such as CCLM, MMLM, CCCM, GLM, the mode with mode information inherited from a merge-like candidate list, multi-hypotheses CCLM, and/or any cross-component mode with syntax belonging cross-component branch (containing multiple cross-component modes) and not belonging to tradition intra prediction modes. Combining with cross-component mode refers to that the candidate block is coded using modes such as chroma fusion (or named LM assisted Angular/Planar Mode), inter CCLM, inter CCCM, and/or any traditional mode with syntax not belonging to cross-component branch but using the cross-component information to generate the prediction.

In some embodiments, when checking the validation of a neighboring coding block, a second-round valid checking is further used when the mentioned valid checking (e.g., neighboring block not being cross-component mode or neighboring block not using/combining cross-component mode), the motion vectors and/or block vectors of the neighboring block can be used to find the cross-component models. If the model is found, a second-round valid checking for the neighboring block is satisfied and the found models can be inserted in the list; otherwise, the neighboring block is not valid for inserting. When scanning the spatial neighboring blocks, a candidate is added into the list if the candidate is valid. Variations of how to use motion vector and/or block vectors to find the model may reference the descriptions related to temporal model information from collocated blocks in this disclosure.

In some embodiments, when the candidate type is temporal model information from collocated blocks, the collocated block may be from the block in the reference picture or the pre-defined collocated picture as inter mode by using the current block position and/or the current block motion. In some embodiments, when the candidate type is temporal model information from collocated blocks, the collocated block may be from the block in the reference picture or the pre-defined collocated picture as inter mode by using the current block position and/or the neighboring block motion.

For example, when the current block position and/or the current block motion are used to locate the collocated block, and when the current block is coded by inter prediction mode, the collocated block is referred by the motion information (including the motion vectors and the reference picture indicated by the reference index) of the current block. If the current block is a subblock motion mode (e.g., affine mode), each subblock in the current block has its own collocated temporal model information. Collocated temporal information from all or any subset of collocated temporal model information referred by the different subblock motions of each subblock are added into the list. For another example, when the reference picture indicated by the reference index is different from the pre-defined collocated picture, which can be the collocated picture used for temporal motion vector prediction in inter mode or any collocated picture specified in the standard to keep the motion or cross-component model information stored and available for the current block, the temporal information from the reference picture is forbidden to be used. For another example, when the reference picture indicated by the reference index is different from the pre-defined collocated picture, which can be the collocated picture used for temporal motion vector prediction in inter mode or any collocated picture specified in the standard to keep the motion or cross-component model information stored and available for the current block, the motion vector is scaled to refer the pre-defined collocated picture and the scaled motion vector is used to find the collocated block in the collocated picture to get the cross-component model in the collocated block. The scaling process is shown in Section V.c “Inherit temporal neighboring model parameters” and Section III.b “Temporal Candidate Derivation”.

For example, when the current block position and/or the neighboring block motion are used to locate the collocated block, the temporal model information can be from the collocated block referred by the motion information of the neighboring blocks for the current block. Similar to when the current block position and/or the current block motion are used to locate the collocated block, the forbidden method or the scaling method can be used in the case of when the current block position and/or the neighboring block motion are used to locate the collocated block. If the proposed methods are applied to an IBC block or any mode using block vectors (in the case of using the current block position and/or the current block motion, the current block being IBC; in the case of using the current block position and/or the neighboring block motion, the neighboring block being IBC), block vector information is used as motion vector where the block vector information is determined by signalling and/or template matching in a pre-defined searching range like intraTMP and/or any implicit or explicit pre-defined rules. More details can be found in Section V.c “Inherit temporal neighboring model parameters”.

In some embodiments, for the candidate type being “history-based model information”, a history-based table (the FIFO table) is built by storing the model information from previous coded blocks. The table can be reset as the beginning and/or the end of a CTU, slice, picture, tile, and/or sequence. One or more history-based candidates can be added into the candidate list by the order from the head to tail of the table or from the tail to head of the table.

In some embodiments, when the candidate type is “pairwise average model information”, the model information of a candidate is derived based on the model information from more than one of the previous candidates in the list. For example, the video coder may average and/or modify the model parameters of more than one candidate as the to-be-applied model parameters. For another example, the video coder may combine more than one prediction as the final prediction, where each of more than one prediction is generated by applying one of models in the candidate list.

In some embodiments, the default model information is added if the list is not full after inserting all pre-defined candidates. For example, the default model can be CCLM models. The default alpha (or named as α, a, or scaling parameters) are {0, 1/8, −1/8, 2/8, −2/8, 3/8, −3/8, . . . }, and the beta (or named as β, b, or offset parameter) is based on the selected default alpha, average neighboring reconstructed luma sample value, and average neighboring reconstructed chroma (Cb/Cr) sample value.

In some embodiments, the candidate list for the inter chroma block is unified with the candidate list for intra chroma block and/or can be generated based on the candidate list for intra chroma block by further including inter-specific candidates (e.g., temporal model information referred by current motion) and/or can be any subset of the candidate list for intra chroma block.

In some embodiments, when building modelList, one or more self-derived cross-component candidates are included. The self-derived cross-component candidates are described in Section IV.L. In some embodiments, the self-derived cross-component candidates are added only when the candidate list (i.e., modelList) does not contain enough inherited candidates. For example, the self-derived candidates are added before the default candidates or treated as the default candidates. In some embodiments, the self-derived cross-component candidates are added in any pre-defined position in the modelList. For example, the position is after the spatial adjacent candidates. For another example, the position is after the spatial non-adjacent candidates. For another example, the position is after all or any subset of temporal candidates. After building the list, in some embodiments, the list is reordered as described in Section V.k “Reorder the candidate list.”

c. Signaling of Enabling and Selecting Model information

(In this section, the term “inter CCLM” refers to “inter CCLM or inter CCCM”.) In some embodiments, when not applying the proposed inter CCLM (or inter CCCM) method described above, the prediction of current block is from original inter prediction. In some embodiments, the choice between applying inter CCLM or not applying inter CCLM depends on signaling.

In some embodiments, the signalling refers to a coded TU/TB/CU/CB level flag. The flag may or may not depend on context to code. In some embodiments, the TU/TB flag is signalled only if the TU/TB's luma Cbf is non-zero and the enabling flag for the inter mode is true. For example, the CU/CB flag is signalled only if the CU/CB's luma Cbf is non-zero and the enabling flag for the inter mode is true. The enabling flag for the inter mode means the CU's predMode is MODE_INTER when the proposed inter CCLM (or inter CCCM) is supported for all inter modes. When inter CCLM (or inter CCCM) is supported for IBC, the enabling flag for IBC is checked first and the signalling for inter CCLM (or inter CCCM) is coded/decoded in response of the CU's predMode being MODE_IBC.

In some embodiments, when inter CCLM (or inter CCCM) is supported for only CIIP, the enabling flag for CIIP is checked first and the signalling for inter CCLM (or inter CCCM) is coded/decoded in response of the CIIP flag being true. When the proposed inter CCLM (or inter CCCM) is supported for only merge, the merge flag is checked first and the signalling for inter CCLM (or inter CCCM) is coded/decoded in response of the merge flag being true. When the proposed inter CCLM (or inter CCCM) is supported for only AMVP, the merge flag is checked first and the signalling for inter CCLM (or inter CCCM) is coded/decoded in response of the merge flag being false. The proposed inter CCLM (or inter CCCM) can be supported only for any pre-defined subset of merge modes, any pre-defined subset of inter modes, or any pre-defined subset of non-intra modes.

In some embodiments, when the signaling indicates to apply inter CCLM (or inter CCCM), additional signaling is used to select one or more models from total candidates. The candidate index is referred as modelIdx in this disclosure. If the modelList containing total candidates (e.g., candidates as described in Section IV.b “Building a candidate list that includes cross-component models”, CCLM_LT, CCLM_L, CCLM_T, MMLM_LT, MMLM_L, MMLM_T) or any subset of candidates are reordered by the methods in the Section V.k, the additional signalling specifies the candidate index in the reordered list. For example, if one LM mode is selected, the LM prediction is generated by the selected one LM. For another example, if more than one LM modes are selected, the LM prediction is generated by blending hypotheses of predictions from multiple LM modes.

In some embodiments, the additional signaling is not required and the one or more models are selected according to an implicit rule. For example, in some embodiments, the one or more selected models are implicitly determined, or that the one or more models used for the current block are determined or selected without signaling modelIdx. In some embodiments, the first candidate in the list may be selected. If the list is reordered by the template cost, the first candidate is the candidate with the smallest template cost.

In some embodiments, the original inter prediction (generated by motion compensation) is used for luma and the predictions of chroma components are generated by CCLM and/or any other LM modes. In some embodiments, the current CU may be viewed (categorized) as an inter CU, intra CU, or a new type of prediction mode (neither intra nor inter).

In some embodiments, the one or more LM modes (i.e., cross-component modes), which will be used to generate the one or more hypotheses of predictions for LM assisted Angular/Planar Mode/inter CCLM/inter CCCM/MH CCLM, are selected from a pre-defined merging candidate list (i.e., modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled and/or can be inferred as 0 or a default value. For example, in some embodiments, the one or more selected models (i.e., the modelIdx) is implicitly determined, or that the one or more models used for the current block are determined or selected without signaling modelIdx. In some embodiments, the first candidate in the list may be selected. If the list is reordered by the template cost, the first candidate is the candidate with the smallest template cost. In some embodiments, the used candidate(s)/model(s) is implicitly selected from the list by using a pre-defined rule based on the coding information of the block for the to-be-used candidate. In some embodiments, when building modelList, one or more predefined candidates may be added. The pre-defined candidates may include any subset/extension of the following candidates and/or more candidates:
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can also be applied to IBC blocks or the blocks with any IBC sub-modes (e.g., IBC merge or IBC AMVP or any IBC mode under IBC syntax). The term “inter” in this disclosure can be changed to IBC. That is, in some embodiments, for chroma components, the block vector prediction can be combined or replaced with cross-component prediction.

d. Generate Prediction Hypotheses for Current Chroma using Model Information

In some embodiments, prediction or reconstruction-based model is used to generate one hypothesis of prediction for the current chroma component. In some embodiments in which a prediction based linear model is used, the derived model parameters are applied to the predicted samples for the first component (Y) to get the predicted samples for the second or third component.

$$P ( i , j ) = a \cdot {pred}_{L}^{′} ( i , j ) + b$$

The predicted samples for the first component are down-sampled with the downsampling filters (which may be fixed at one-predefined filter or selected among some candidate filters).

In some embodiments in which a reconstruction based linear model is used, the derived model parameters are applied to the reconstructed samples for the first component (Y) to get the predicted samples for the second or third component (Cb or Cr).

$$P ( i , j ) = a \cdot {reco}_{L}^{′} ( i , j ) + b$$

The reconstructed samples for the first component are down-sampled with the downsampling filters (which may be fixed at one-predefined filter or selected among some candidate filters).

Prediction-based or reconstruction-based convolution model is similar to the proposed methods for the prediction-based or reconstruction-based linear model. The main difference is that the model coefficient pattern follows CCCM (not CCLM) and the luma samples may or may not be down-sampled first.

In some embodiments, multiple hypotheses (MH) of cross-component predictions are blended or multiple models are used to generate a hypothesis of prediction for the current block. Multiple-hypothesis CCLM is used to blend the predictions from multiple CCLM methods. The term “CCLM methods” may refer to all cross-component modes. The to-be-blended CCLM methods can be (but are not limited to) one of the above mentioned CCLM methods (e.g., CCLM, MMLM, CCCM, GLM, CCRM, . . . ) and/or models implicitly selected from a candidate list by using a pre-defined rule based on the coding information of the block. A weighting scheme may be used for blending the multiple hypotheses.

In some embodiments, for chroma components, in addition to original inter prediction (generated by motion compensation which can be uni-prediction and/or bi-prediction, multiple hypotheses of prediction from multiple motion candidates which may refer to one or more merge candidates and/or one or more AMVP candidates, and/or any combination of above, or which can be only uni-prediction), one or more hypotheses of predictions (generated by CCLM and/or any other LM modes) are used to generate the current prediction.

In some embodiments, the current prediction is the weighted sum of inter prediction and CCLM (or CCCM, or other LM modes) prediction. In some embodiments, the inter prediction can be generated by any inter mode mentioned in the above introduction/documents. For example, the inter mode can be regular merge mode. For another example, the inter mode can be CIIP mode. For another example, the inter mode can be GPM or any GPM variations (e.g., GPM intra referring one prediction unit using intra prediction).

In some embodiments, inter CCLM (or inter CCCM) is supported only when one or more of the pre-defined inter mode is used for the current block, or inter CCLM (or inter CCCM) is supported when anyone (or more than one) of the enabling flag(s) of the pre-defined inter mode is(are) indicated as enabled. A video coder that supports inter CCLM (or inter CCCM) may allow the prediction of the current block to be chosen between applying inter CCLM (or inter CCCM) or not applying inter CCLM (or inter CCCM).

In some embodiments, when applying inter CCLM (or inter CCCM), the prediction of current block is generated by blending one or more hypotheses of predictions (generated by CCLM and/or any other LM modes) with original inter prediction. The video coder may blend the chroma prediction for existing inter mode and the prediction from LM according to:

$$Predfinal = ( wInter * PredInter + wLM * PredLM + 2 ) ≫ 2$$

where a weighting rule is applied to determine wInter and wLM according to:
   If both top and left are intra (or any cross-component mode), (wInter, wLM)=(1, 3)
   Otherwise, if one of top and left is intra, (wInter, wLM)=(2, 2)
   Otherwise, (wInter, wLM)=(3, 1)

For another example, the weighting follows CIIP weighting rules. For example, predInter=inter prediction after OBMC (if OBMC is used). For another example, predInter=inter prediction before OBMC (OBMC can be applied after blending).

In some embodiments, when applying inter CCLM (or inter CCCM), the prediction of current block is generated by replacing the original inter prediction with one or more hypotheses of predictions (generated by CCLM and/or any other cross-component modes).

For another example, if CCLM (or CCCM, or other LM modes) mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

e. Selection Between Inherited Model and Self-Derived Model

In some embodiments, a flag can be signaled to indicate/select if the re-derived model is used. If the flag is 0, the cross-component model used to encode the neighbor merge candidate is inherited. If the flag is 1, the re-derived method is used. In some embodiments, an implicit rule (instead of using an additional flag) is used to determine whether to use the re-derived model. In some embodiments, if no model can be inherited during building the modelList, or the spatial adjacent and/or non-adjacent candidates and/or history candidates and/or temporal candidates and/or all or any subset (e.g., before default candidates) of mentioned candidates in this invention are not available, the re-derived model may be used. In some embodiments, when selecting a model to inherit, the candidate with the smallest cost (e.g., the first candidate in the modelList) is implicitly selected to generate the cross-component prediction. In some embodiments, an index is signaled to select one or more candidates from the modelList. More details on signaling the selection of candidate model information can be found in Section IV.c “Signaling of Enabling and Selecting Model information”.

### V. Cross-Component Mode in Candidate List

a. Inherit Cross-Component Model (CCM) Information

In some embodiments, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information may include but not limited to prediction mode (e.g., CCLM, MMLM, CCCM, CCCM with multi-models, 2-parameter GLM, 3-parameter GLM (GLM model with luma terms), information indicating whether non-linear terms are used in the model, model index for indicating which model shape is used in convolutional model, classification threshold for multi-model, information to indicate non-downsampled samples are used in convolutional model, down-sampling filter flag (whether to do down-sampling), down-sampling filtering index when multiple down-sampling filters are used, information indicating whether multiple down-sampling filters are used, number of neighboring lines used to derive model, types of templates used to derive model (e.g., top-left templates, top templates, left templates), post-filtering flag and model parameters.

In some embodiments, a mixed CCCM model consist of various terms (e.g., spatial term, gradient term, location term, non-linear term and bias term) can be inherited. In addition to storing model parameters, a prediction mode can be stored in the CCM information to indicate that the inherited model is a mixed CCCM model comprising various terms. If there are multiple types of mixed CCCM models, a model index can also be stored in the CCM information to indicate which type of mixed CCCM model is inherited. For example, gradient and location based CCCM (GL-CCCM) is a mixed CCCM model which consists of one spatial term in center position, two gradient terms for horizontal direction and vertical direction, two location term X and Y for the relative horizontal location and relative vertical location, one non-linear term and one bias term. A prediction mode can be stored in the CCM information to indicate that the inherited model is a GL-CCCM model.

b. Inheriting Spatial Neighboring Model Parameters

In some embodiments, the inherited model parameters can be from a block that is an immediate neighboring block. The models from blocks at pre-defined positions are added into the candidate list in a pre-defined order. The pre-defined order may be any possible order of the spatial neighbor block.

In some embodiments, the pre-defined positions and the pre-defined order can be the same as those of spatial candidates for inter merge mode. In some embodiments, the pre-defined positions may be the positions depicted in FIG. 4. The pre-defined order can be B0, A0, B1, A1 and B2.

In some embodiments, assume the position, width and height of the current block are (x, y), W and H respectively, the pre-defined positions can include positions immediate above the current block, such as (x+W>>1, y−1) or (x+(W+1)>>1, y−1), if W is greater than or equal to a threshold TH. The pre-defined positions can also include positions immediate left to the current blocks, such as (x−1, y+H>>1) or (x−1, y+(H+1)>>1), if H is greater than or equal to a threshold TH. TH can be 2, 4, 8, 16, 32, or 64. The pre-defined positions include the positions at the immediate above (W>>1) or ((W>>1)−1) position if W is greater than or equal to TH, and the positions at the immediate left (H>>1) or ((H>>1)−1) position if H is greater than or equal to TH.

In some embodiments, there is a maximum number of inherited models from spatial neighbors that can be added into the candidate list, and the maximum number is smaller than the number of pre-defined positions.

c. Inherit Temporal Neighboring Model Parameters

In some embodiments, if the current slice/picture is a non-intra slice/picture, the inherited model parameters can be from the block in the previous coded slices/pictures. In some embodiments, the current block position is at (x, y) and the block size is w×h. The inherited model parameters can be from the block at some pre-defined positions of the previous coded slices/picture. In some embodiments, the pre-defined positions can be the same as the pre-defined positions of temporal candidates of inter merge mode. In some embodiments, the pre-defined positions can be (x+Δx, y+Δy) or (x_{mid}+Δx, y_{mid}+Δy), where

$$( {x}_{mid} , {y}_{mid} ) = ( x + \frac{w}{2} , y + \frac{h}{2} ) .$$

The two value sets αₓ and α_{y} are defined as:

$${α}_{x} = \{ {α}_{x 1} , {α}_{x 2} , {α}_{x 3} , ... , {α}_{xn} \} , {α}_{xi} < {α}_{xj} if i < j$$

$${α}_{y} = \{ {α}_{y 1} , {α}_{y 2} , {α}_{y 3} , ... , {α}_{yn} \} , {α}_{yi} < {α}_{yj} if i < j$$

All values in αₓ and α_{y} are positive numbers. For example, (Δx, Δy) can be (±αₓᵢ×w, α_{yi}×h), (±αₓᵢ×w, 0), (0, ±α_{yi}×h). For example, αₓ−α_{y}. For example, αₓ−α_{y}={1, 2, 3, 4, 5}. For example, αₓ≠α_{y}. For example,

$${α}_{x} = \{ \frac{1}{2} , 1 , \frac{3}{2} , 2 , \frac{5}{2} \} and {α}_{y} = \{ 1 , 2 , 3 , 4 , 5 \} .$$

In some embodiments, the pre-defined positions (x′, y′) are inside the corresponding area of the current encoding block, i.e., x≤x′<x+w and y≤y′<y+h. The pre-defined positions can be

$$( x , y ) , ( x + w - 1 , y ) , ( x , y + h - 1 ) , ( x + w - 1 , y + h - 1 ) , \\ ( x + \frac{w}{2} , y + \frac{h}{2} ) , ( x , y + \frac{h}{2} ) , ( x + \frac{w}{2} , y ) .$$

In some embodiments, the pre-defined positions (x′, y′) are outside of the corresponding area of the current encoding block, i.e., x′<x+or x′>x+w, and y′<y or y′>y+h. The pre-defined positions can be (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In some embodiments, the models from the positions closer to (x, y) are added into the final merge candidate list first. The previous coded picture, from which the inherited parameter model is obtained, is referred to as the collocated picture hereafter. In some embodiments, the previous coded picture the inherited parameter model is from, i.e., the collocated picture, is one of the pictures in the reference lists. In some embodiments, the collocated picture can be the same as the collocated picture of inter merge mode.

In some embodiments, the collocated picture is signaled in the picture/slice header. The reference list and the reference index are signaled in the picture/slice header. For example, the collocated picture is selected as L0[0]. For another example, the collocated picture is selected as L1[0].

In some embodiments, the collocated picture is selected as the picture in the reference lists whose POC difference between the respective picture and the current picture is the smallest. In some embodiments, the collocated picture is selected as the picture in the reference lists whose QP is larger. In some embodiments, the positions in the previous coded slices/pictures where the inherited parameter model is from is determined by the motion vector of a neighboring block. Let Δx and Δy be the horizontal and vertical displacement determined based on the selected motion vector of the neighboring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

In some embodiments, a particular flag (e.g., RprConstraintsActiveFlag) of the collocated picture may be used to indicate that the temporal candidates from the collocated picture are not inherited.

d. Inherit Non-Adjacent Spatial Neighboring Models

In some embodiments, the inherited model parameters can be from blocks that are non-adjacent spatial neighboring blocks. The models from blocks at pre-defined positions are added into the candidate list in a pre-defined order. In some embodiments, the pre-defined positions and the pre-defined order are the same as those of non-adjacent spatial neighboring candidates for inter merge mode.

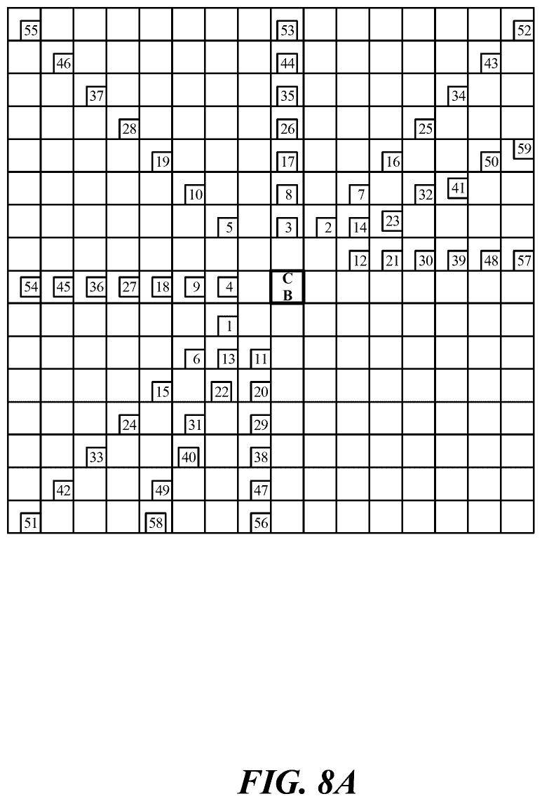

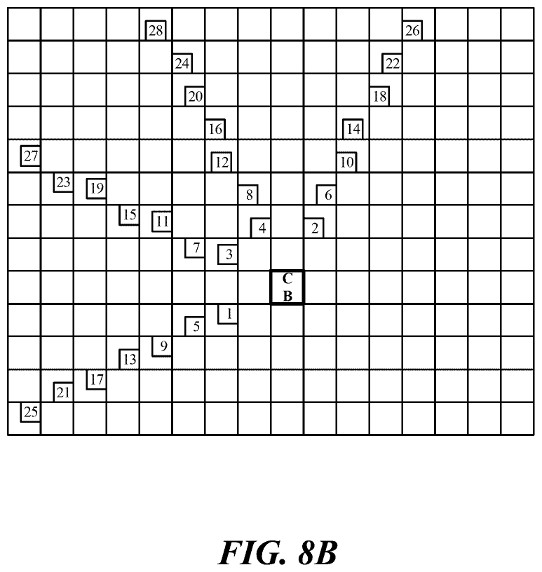

FIGS. 8A-B illustrate a current block (labeled CB) and its non-adjacent spatial neighboring blocks, from which model parameters may be inherited. The figure also illustrates the pre-defined positions and their pre-defined order. FIG. 8A shows non-adjacent spatial positions in their pre-defined order according to a first pattern (Pattern 1). FIG. 8B shows non-adjacent spatial positions in their pre-defined order according to a second pattern (Pattern 2). The positions of the numbered squares are the pre-defined positions. The number inside each square indicates the pre-defined order. Positions in Pattern 1 is added into the CCP merge candidate list before positions in Pattern 2. The distance between each pre-defined positions are proportional to the width and height of the current block.

In some embodiments, there is a maximum number of inherited models from non-adjacent spatial neighbors that can be added into the candidate list, and the maximum number is smaller than the number of pre-defined positions.

e. Inheriting Model Parameters from History Table

In some embodiments, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In some embodiments, the order of adding historical candidate into the list can be from the beginning of the table to the end of the table. In some embodiments, the order of adding historical candidate into the list can be from the end of the table to the beginning of the table.

In some embodiments, one cross-component model history table can be maintained for storing the previous cross-component model (i.e., CCM information), and the cross-component model history table can be reset at the start of the current picture, current slice, current tile, every M CTU rows or every N CTUs, N and M can be any value greater than 0. In some embodiments, the cross-component model history table can be reset at the end of the current picture, current slice, current tile, current CTU row or current CTU.

In some embodiments, multiple history table are used for storing cross-component models of different types. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In some embodiments, when adding historical candidates from multiple history tables to the candidate list, the adding order can be from the beginning of to the end of a certain table, and then the next history table is added in the same order or in a reversed order.

f. Vector Propagated CCM Information

In some embodiments, after encoding/decoding a block, the cross-component model (CCM) information of the current block is derived and stored in the current block. The stored CCM information can be referenced by subsequent or following coding blocks. The following coding blocks may inherit CCM information from the current block. The stored CCM information can be inherited by spatial candidates, non-adjacent candidates, temporal candidates, historical candidates, and/or other types of candidates.

In some embodiments, if the current block is not cross-component prediction (CCP) coded and there are block vectors available in the current block (e.g., the current luma block is coded in IBC or IntraTMP mode, or the collocated luma block is coded in IBC or IntraTMP mode), the CCM information of the current block can be derived by copying the CCM information of the reference block located by the block vector. (A CCP coded block is one that is coded by using cross-component model, such as the inherited cross-component model, the self-derived cross-component model, cross-component model used in chroma fusion which means the chroma prediction is based on adding one or more hypotheses of cross-component prediction to one or more existing hypotheses of prediction of non-cross-component prediction, or any combination of the above.

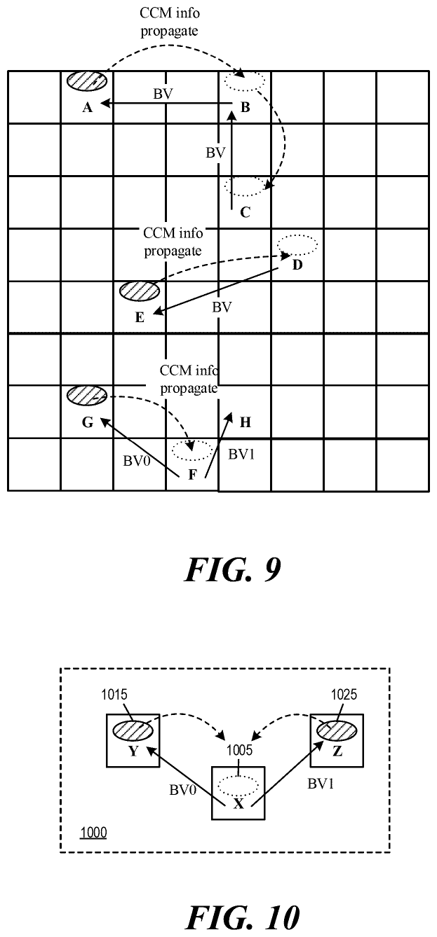

FIG. 9 illustrates propagation of cross-component model (CCM) based on block vectors. The figure illustrates blocks A, B, C, D, E, F, G, and H. In the example illustrated, blocks A, E, G are coded in cross-component model (e.g., CCLM, MMLM, GLM, CCCM, Chroma Fusion). Block B is not CCP coded but there are block vectors available at block B. The reference block A is located by the block vector. The CCM information of the reference block A, which uses cross-component model, is copied and stored in (or for) block B. In some embodiments, if the reference block located by the block vector is also not CCP coded, but there is CCM information stored in the reference block, the CCM information of the current block can be derived by copying the CCM information stored in the reference block. For example, as shown in FIG. 9, the current block C has block vector available, and its reference block B, which is not CCP coded, has CCM information stored. The CCM information of block B is copied and stored in (or for) block C. The CCM information stored in block B was copied from block A. Hence the CCM information of block A is propagated to block C. In some embodiments, if the reference block located by the block vector is not CCP coded and does not have CCM information stored, no CCM information is stored for the current block.

In some embodiments, when the current block has multiple block vectors available (e.g., the block vector can be bi-directional, the block can have multiple IntraTMP block vectors, or the current chroma block is collocated with multiple luma blocks and more than one of the luma blocks have block vectors), to derive the CCM information of the current block, if only one of the reference blocks located by the block vectors has CCM information, the CCM information from the reference block which has CCM information is copied to and stored in the current block. For example, as shown in FIG. 9, suppose block F has two block vectors and has two reference blocks G and H. Block G has CCM information and block H does not. The CCM information of block G is copied to and stored in block F.

In some embodiment, when the current block has multiple block vectors, and more than one of the reference blocks located by the block vectors has CCM information, the video coder determines/derives the CCM information to be stored in (or for) the current block based on the CCM information of the more than one reference blocks. FIG. 10 illustrates a current block having two block vectors identifying two reference blocks and that both have CCM information. As illustrated, a current block (block X) has two reference blocks (block Y and block Z) in a same current picture 1000. The reference block Y is identified by block vector BV0 and has CCM information 1015. The reference block Z is identified by block vector BV1 and has CCM information 1025. Block Y and Block Z may or may not be coded by CCP. The video coder determines the CCM information 1005 for the current block X based on the CCM information 1015 and the CCM information 1025.

The video coder in different embodiments determines the current block CCM information 1005 differently. For example, in some embodiments, the current block CCM information 1005 is derived by combining all or a subset of the CCM models of its reference blocks (e.g., CCM models 1015 and 1025 of reference blocks 1010 and 1020).

In some embodiments, when the current block (e.g., current block X of FIG. 10) has multiple block vectors, and more than one of the reference blocks (e.g., reference blocks Y and Z of FIG. 10) located by the block vectors has CCM information, one of the reference blocks is selected based on a set of pre-defined rules. The CCM information of the selected reference block is then copied and stored in the current block. In some embodiments, the reference block which is CCP coded is selected. In some embodiments, the reference block which is intra coded is selected. In some embodiments, the reference block which is inter or IBC coded is selected.

In some embodiments, the reference block whose distance to the current block is the smallest is selected. The CCM information of the selected reference block is copied to and stored in the current block. The distance between the reference block and the current block, located at (xᵣ, yᵣ) and (x_{c}, y_{c}) respectively, can be computed by Euclidean distance d=\sqrt{(xᵣ−x_{c})²+(yᵣ−y_{c})²}. (xᵣ, yᵣ) and (x_{c}, y_{c}) can be the top-left, top-right, bottom-left, bottom-right, or center positions of the reference block and the current block. The distance metric can also be Manhattan distance or Minkowski distance.

For some embodiments, the reference block which has the smallest horizontal distance, |xᵣ−x_{c}|, is selected. The CCM information of the selected reference block is copied to and stored in the current block. For some embodiments, the reference block which has the smallest vertical distance, |yᵣ−y_{c}|, is selected. The CCM information of the selected reference block is copied to and stored in in the current block.

For some embodiments, the rules described previously can be combined, and not all the rules described previously need to be applied. For example, the reference block which is CCP coded is selected. If there are more than one CCP coded reference blocks, then the block which has the shortest distance to the current block among the CCP coded reference blocks is selected. If there are more than one CCP coded reference blocks whose distances to the current block are the smallest, the reference block which has the smallest horizontal distance, |xᵣ−x_{c}|, is selected. For another example, the reference block which is CCP coded is selected. If there are more than one CCP coded reference blocks, then the block which has the shortest distance to the current block among the CCP coded reference blocks are selected. If there are more than one CCP coded reference blocks whose distances to the current block are the smallest, the reference block which has smallest vertical distance, |yᵣ−y_{c}|, is selected. The CCM information of the selected reference block is copied to and stored in the current block.

In some embodiments, if the current block is not CCP coded and there are motion vectors available in the current block (e.g. the current luma block is inter-coded), the CCM information of the current block can be derived by copying the CCM information of its reference block in a reference picture, located by the motion vectors of the current block.

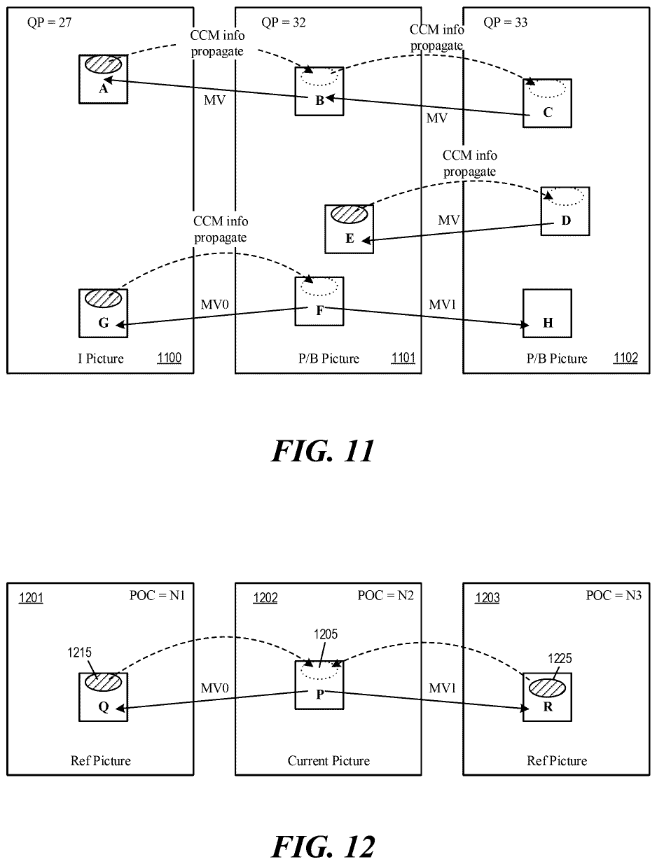

FIG. 11 illustrates examples of CCM information propagation based on motion vectors. The figure illustrates several blocks A through H. The blocks A, E, G are coded by using cross-component model (e.g., CCLM, MMLM, GLM, CCCM). As illustrated, block B is not CCP coded and there are motion vectors available at block B. The reference block A is located by the motion vector. The CCM information of the reference block A, which uses cross-component model, is copied and stored in block B.

In some embodiments, if the reference block located by the motion vector is also not CCP coded, but there is CCM information stored in the reference block, the CCM information of the current block can be derived by copying the CCM information stored in the reference block. In the example of FIG. 11, the block C has motion vector available, and its reference block B, which is not CCP coded, has CCM information stored. The CCM information of block B is copied and stored in block C. The CCM information stored in block B was copied from block A. Hence the CCM information of block A is propagated to block C. In some embodiments, if the reference block located by the motion vector is not CCP coded and does not have CCM information stored, no CCM information is stored for the current block.

In some embodiments, when the current block is inter-coded with bi-directional prediction, to derive the CCM information of the current block, if only one of the reference blocks located by the motion vectors has CCM information, the CCM information from the reference block which has CCM information is copied to and stored in the current block. For example, as shown in FIG. 11, block F is inter-coded with bi-directional prediction, the two reference blocks located by the motion vectors (MV0 and MV1) of block F are block G and block H. Block G has stored CCM information and block H does not. The CCM information of block G is copied to and stored in block F.

In some embodiments, when the current block is inter-coded with bi-directional prediction, and both reference blocks located by the motion vectors have stored CCM information, the video coder determines/derives the CCM information stored in the current block based on the CCM information of the more than one reference blocks. FIG. 12 illustrates a current block having two motion vectors identifying two reference blocks and that both have CCM information. As illustrated, a current block (block P) is inter-coded with bi-directional prediction in current picture 1202. The two reference blocks (block Q and block R) are located by motion vectors in different reference pictures 1201 and 1203. The reference block Q is located by block vector MV0 and has CCM information 1215. The reference block R is located by block vector MV1 and has CCM information 1225. Reference blocks Q and R may or may not be coded by CCP. The video coder determines the CCM information 1205 for the current block P based on the CCM information 1215 and the CCM information 1225.

The video coder in different embodiments determines the current block CCM information 1205 differently. For example, in some embodiments, the current block CCM information 1205 is derived by combining of all or a subset of the CCM models 1215 and 1225 of the reference blocks Q and R. For another example, ins some embodiments, one of the reference blocks is selected based on a set of pre-defined rules. The CCM information of the selected reference block is then copied and stored in the current block.

In some embodiments, to select from the one or more reference blocks for obtain the CCM information, the reference block which is CCP coded is selected. In some embodiments, the reference block which is intra coded is selected. In some embodiments, the reference block which is inter- or IBC-coded is selected.

In some embodiments, the reference block whose reference picture (i.e., the picture the reference block is in) has the smaller POC distance to the current picture is selected. In some embodiments, the reference block whose reference picture has the smaller/smallest QP difference from the current picture is selected. In some embodiments, the reference block whose reference picture has the smaller QP value is selected. In some embodiments, the reference block whose reference picture has the larger QP values is selected.

In some embodiments, the reference block that is indicated by the L0 motion vector is selected. In some embodiments, the reference block that is indicated by the L1 motion vector is selected. In some embodiments, the rules described previously can be combined, and not all the rules described previously need to be applied. For example, the reference block which is CCP coded is selected. If both blocks are CCP coded, then the block whose reference picture has the smaller POC distance to the current picture is selected. If both blocks are CCP coded and has the same POC distance to the current picture, the reference block whose reference picture has the smaller QP difference from the current picture is selected. If both blocks are CCP coded, has the same POC distance to the current picture, and has the same QP difference from the current picture, then the reference block whose reference picture has the smaller QP value is selected. For another example, the block whose reference picture has the smaller POC distance to the current picture is selected. If both blocks have the same POC distance to the current picture, the reference block whose reference picture has the smaller QP difference from the current picture is selected. If both blocks have the same POC distance to the current picture and have the same QP difference from the current picture, then the reference block whose reference picture has the smaller QP value is selected.

In some embodiments, if the RprConstraintsActiveFlag of the reference picture is true, no CCM information is retrieved and stored. In some embodiments, if the RprConstraintsActiveFlag of the reference picture is true, the motion vector is scaled according to the ratio between the current picture and the reference picture (the ratio is determined based on e.g., the current picture's and the reference picture's respective scaling windows).

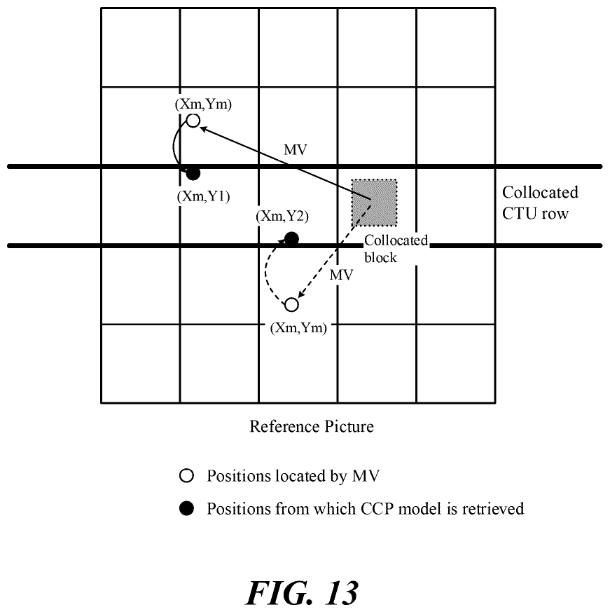

In some embodiments, the position located by the motion vector is in the collocated CTU row in the reference picture of the current CTU row. FIG. 13 illustrates a position located by the motion vector in a reference picture. In some embodiments, if the position located by the motion vector is outside of the collocated CTU row, the vertical-component of the motion vector is clipped. In the example illustrated in FIG. 13, the minimum and the maximum vertical position of the current CTU row are Y1 and Y2 respectively. Assume the position located by the motion vector is (Xm, Ym). If Ym<Y1, then the position is changed to (Xm, Y1). If Ym>Y2, then the position is changed to (Xm, Y2).

g. Inherit from Fusion Mode

Fusion mode refers to mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In some embodiments, when inheriting the cross-component model parameters from the block/position coded by chroma intra fusion mode, the model parameters for obtaining the CCP coded intra prediction are inherited and further refined. In some embodiments, in addition to inheriting and refining the CCP model parameters, the fusion weight, the coding mode of non-CCP coded intra prediction are also inherited. That is, the chroma intra fusion mode is inherited.

h. Storing Temporal Models in an Indexed Table

In some embodiments, CCM information from previous coded slices/pictures are stored in a table, and a picture-level index buffer is created to store the index of the table. The index buffer has the same size as the picture. When referencing the CCM information at position (x, y) inside the collocated picture (as described in Section V.c “Inherit temporal neighboring model parameters”), an index value is retrieved from the position (x, y) in the index buffer of the collocated picture. If the index value indicates that no CCM information is available at position (x, y), no CCM information can be referenced. Otherwise, an item in the table indicated by the index value is obtained as the CCM information to be referenced.

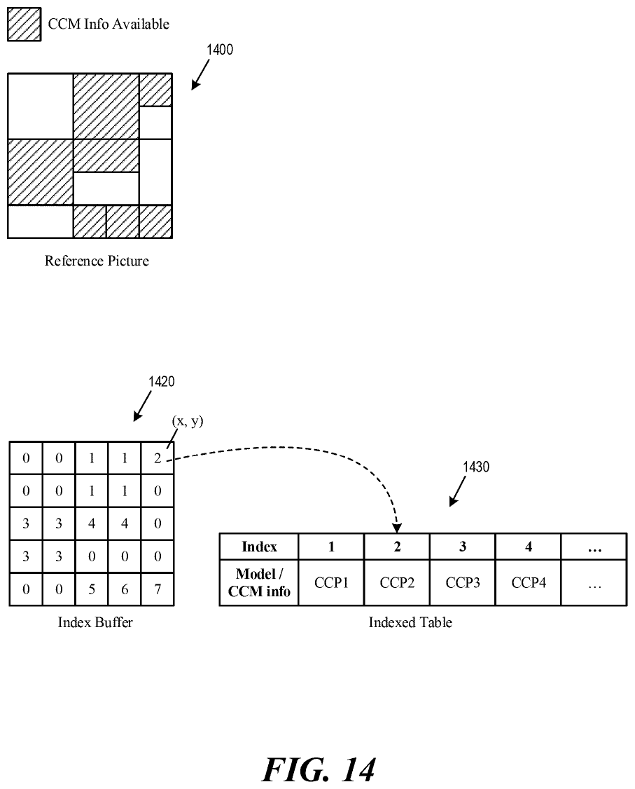

In some embodiments, the table to store CCM information is a picture-level table. CCM information from each picture is stored in a separate table. FIG. 14 conceptually illustrates a picture level index buffer for storing indices of a CCM information storage table. When a pixel block in a future picture selects the current picture as the collocated picture, a set of CCM information (including the model parameters) from the current picture may be inherited as a temporal candidate to encode the pixel block in the future picture in cross-component merge mode. The current picture is denoted as a CCM picture 1400.

The CCM picture 1400 has a corresponding index buffer 1420. When referencing the CCM information at position (x, y) (which may be a pixel position or a block position) inside the CCM picture 1400, an index value is retrieved from the position (x, y) in the index buffer 1420. If the index value indicates that no CCM information is available at position (x, y), no CCM information can be referenced. Otherwise, an item in an indexed CCM table 1430 indicated by the index value is obtained as the CCM information to be referenced. In the example, position (x, y) in the index buffer 1420 has index value ‘2’, which correspond to index 2 position in the indexed CCM table 1430. The index 2 position in the indexed CCM table 1430 stores a set of CCM information labeled “CCP2”. (Index value ‘0’ indicates no CCM information). For a future picture to be able to reference CCM information from the current picture, after the current picture is encoded or decoded, the CCM information from the current picture are stored into corresponding indexed CCM tables and the corresponding index value are stored at the corresponding location in the index buffer.

In some embodiments, one table is created to store CCM information from all pictures. In some embodiments, several tables are used to store CCM information from one picture. A picture can be divided into several regions, with each region corresponding to its own table.

In some embodiments, one table is created for each temporal ID such that CCM information from the layer with the same temporal id is stored in the same table. Pictures having different temporal IDs (or in different temporal ID layers) are in different encoding or decoding hierarchy. Specifically, pictures having temporal ID=0 are coded before pictures having temporal ID=1, which are coded before pictures having temporal ID=2, which are coded before pictures having temporal ID=3, etc., and that pictures having a larger temporal ID may be encoded or decoded based on pictures having a smaller temporal ID.

In some embodiments, after storing CCM information at position (x, y) of the current encoding/decoding picture into the corresponding table, the table index value of that CCM information is saved in the index buffer of the current encoding/decoding picture at position (x, y). If no CCM information is available at position (x, y) (e.g., the CU covering position (x, y) is not coded in cross-component prediction modes, such as CCLM, MMLM, CCCM, CCCM multi-models, chroma fusion, or other cross-component models), the value at position (x, y) in the index buffer is set to indicate that no CCM information is available.

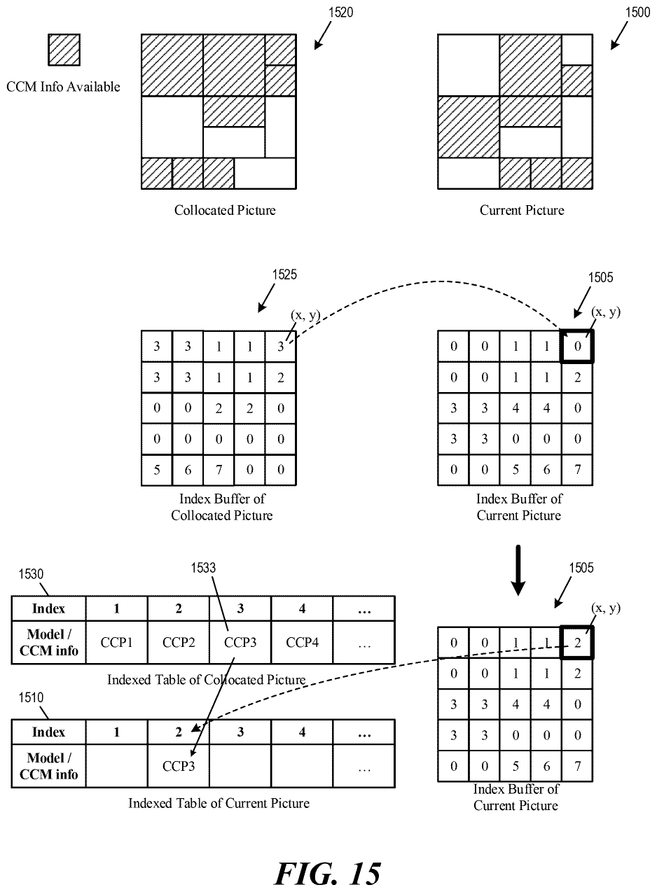

In some embodiments, if CCM information is not available at position (x, y) of the current encoding/decoding picture, the cross-component model indicated by the index value at position (x, y) in the index buffer of the collocated picture can be stored in the indexed table of the current encoding/decoding picture, and the corresponding index value to be stored at position (x, y) in the index buffer of the current encoding/decoding picture. FIG. 15 illustrates copying CCM information from the indexed table of a collocated picture to the indexed table of the current picture. The figure illustrates a current picture 1500 having an index buffer 1505 for accessing CCM information. At position (x, y), the CCM information is not available for current picture 1500, as indicated by index value ‘0’ in the index buffer 1505. On the other hand, a collocated picture 1520 at position (x, y) has CCM information 1533 (“CCP3”) stored in an indexed table 1530, as indicated by index value ‘3’ in the index buffer 1525 of the reference picture 1520. To make the CCM information 1533 for use by the current picture 1500, the CCM information 1533 is copied from the indexed table 1530 to the indexed table 1510 for the current picture 1500. The CCM information 1533 in the indexed table 1510 is indicated by an index value ‘2’ in the index buffer 1505 at position (x, y) for the current picture.

In some embodiments, if CCM information is not available at position (x, y) of the current encoding/decoding picture, and there is a block vector (Δx, Δy) available at the position (x, y) (e.g., the current luma block is coded in IBC or IntraTMP mode, the collocated luma block is coded in IBC or IntraTMP mode), the index value at position (x+Δx, y+Δy) in the index buffer can be stored at position (x, y) in the index buffer of the current encoding/decoding picture.

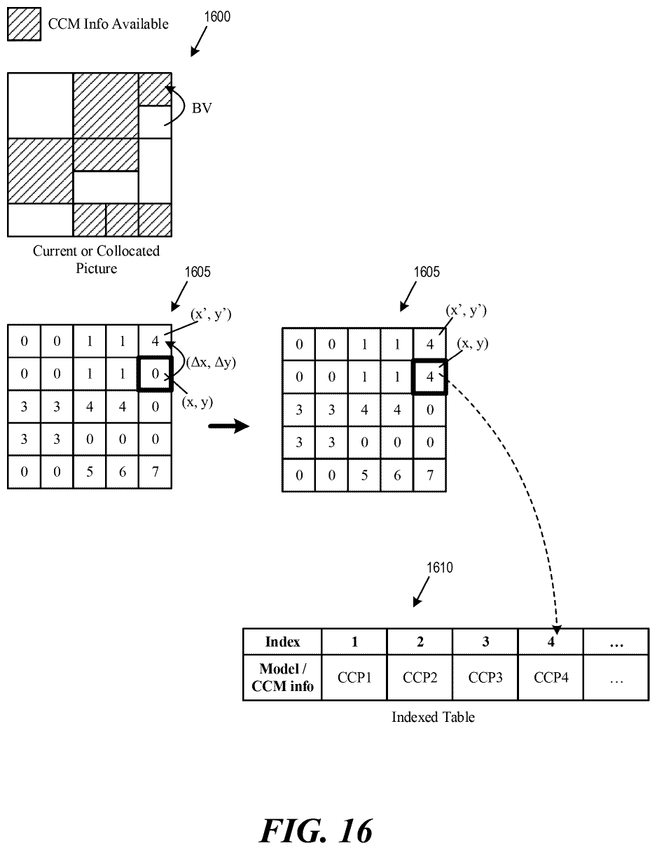

FIG. 16 conceptually illustrates deriving and storing CCM information by copying entries of an index buffer based on block vectors. As illustrated, a CCM picture 1600 (the current picture that has been encoded/decoded or has portions already reconstructed to serve as reference for subsequently coded portions) has an index buffer 1605 for locating CCM information in an indexed table 1610. As illustrated, at position (x, y), the CCM information is not available for the CCM picture 1600, as indicated by value ‘0’ in corresponding position in the index buffer 1605. However, the position (x, y) is coded in a mode (e.g., IBC, IntraTMP) using a BV (Δx, Δy) that point to another position (x′, y′)=(x+Δx, y+Δy) in the reference picture 1600. The position (x′, y′) has CCM information, as indicated by a corresponding non-zero index value (‘4’) in the index buffer 1605 at position (x′, y′). The index value (‘4’) at position (x′, y′) is then replicated at the position (x, y) of the index buffer. This allows the block at (x, y) to be coded by using the CCM information pointed to by index value (‘4’).

In some embodiments, if CCM information is not available at position (x, y) of the current encoding/decoding picture, and there are multiple block vectors available, (Δxi, Δyi), 0<i≤N, N≥1, at the position (x, y) (e.g., the luma block at the position (x, y) can have bi-directional block vector, or the chroma block at the position (x, y) can have multiple collocated luma blocks which have block vectors), the index value at one of the positions (x+Δxi, y+Δyi) in the index buffer can be stored at position (x, y) in the index buffer of the current encoding/decoding picture. In some embodiments, a set of pre-defined rules may be applied to determine how to select one of the block vectors (i.e., select and store the index value and the corresponding cross-component model located by the block vector (Δxi, Δyi)). The rules can be the same as the rules to select one of the reference blocks located by the block vectors described above in Section V.f “Vector propagated CCM information”.

In some embodiments, if CCM information is not available at position (x, y) of the current encoding/decoding picture, and the block at position (x, y) is inter-coded and the motion vector is (Δx, Δy), the index value at position (x+Δx, y+Δy) in the index buffer of the reference picture (also indicated by the motion vector) can be stored at position (x, y) in the index buffer of the current encoding/decoding picture.

In some embodiments, if CCM information is not available at position (x, y) of the current encoding/decoding picture, and the block at position (x, y) is inter-coded and the motion vector is bi-directional (Δxi, Δyi), i=0 or 1. The index value at one of the positions (x+Δxi, y+Δyi) in the index buffer of the reference picture (also indicated by the motion vector) can be stored at position (x, y) in the index buffer of the current encoding/decoding picture.

In some embodiments, there can be a set of pre-defined rules to determine how to select one of the motion vectors (i.e., select and store the index value and the corresponding cross-component model located by the motion vector (Δxi, Δyi)). The rules can be the same as the rules to select one of the reference blocks located by the motion vectors described above in Section V.f.

In some embodiments, if CCM information is not available at position (x, y) of the current encoding/decoding picture, and the block at position (x, y) is inter-coded and the motion vector is (Δx, Δy), the index value at position (x+Δx, y+Δy) in the index buffer of the reference picture, which is also indicated by the motion vector, can be used to retrieve CCM information from the table corresponding to the reference picture. The retrieved CCM information is then stored into the table corresponding to the current picture. The table index value of the retrieved CCM information is saved in the index buffer of the current encoding/decoding picture at position (x, y).

In some embodiments, if CCM information is not available at position (x, y) of the current encoding/decoding picture, and the block at position (x, y) is inter-coded and the motion vector is bi-directional (Δxi, Δyi), i=0 or 1. The index value at one of the positions (x+Δxi, y+Δyi) in the index buffer of the reference picture, which is also indicated by the motion vector, can be used to retrieve CCM information from the table corresponding to the reference picture. The retrieved CCM information is then stored into the table corresponding to the current picture. The table index value of retrieved CCM information is saved in the index buffer of the current encoding/decoding picture at position (x, y).

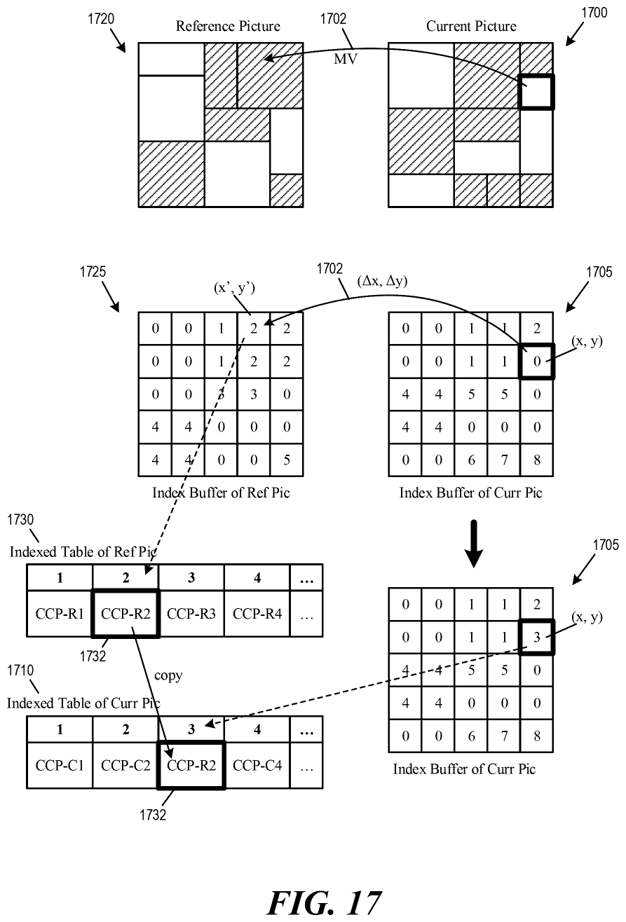

FIG. 17 illustrates deriving and storing CCM information by copying and storing entries of indexed tables based on motion vectors. The figure illustrates a current picture 1700 having an index buffer 1705 for accessing CCM information in an indexed table 1710. At position (x, y), the CCM information is not available for the current picture 1700, as indicated by index value ‘0’ in the index buffer 1705. The position (x, y) is inter-coded by using an MV 1702 that references a reference picture 1720 at position (x′, y′)=(x+Δx, y+Δy). The reference picture 1720 at position (x′, y′) has CCM information 1732 stored in an indexed table 1730, as indicated by index value ‘2 in an index buffer 1725. To make the CCM information 1732 for use by the current picture 1700, the CCM information 1732 is copied from the indexed table 1730 to the indexed table 1710 for the current picture 1700. The CCM information 1732 in the indexed table 1710 is indicated by an index value ‘3’ in the index buffer 1705 at position (x, y) for the current picture 1700.

In some embodiments, there can be a set of pre-defined rules to determine how to select one of the motion vectors (i.e., retrieve the index value located by the motion vector (Δxi, Δyi) and store the corresponding cross-component model in the current table). The rules can be the same as the rules to select one of the reference blocks located by the motion vectors described in Section V.f.

In some embodiments, when deleting a CCM information from a table, all values in the index buffers that indicate to use the to-be-deleted CCM information are reset to indicate that no CCM information is available. Assume the index value of the to-be-deleted CCM information is N, all values in the index buffer that are greater than N will be decreased by 1.

In some embodiments, there's a maximum size limit for a table used to store CCM information. A high-level syntax can be signaled in SPS, PPS, PH or SH to indicate the maximum size limit. If a table has reached its maximum size when attempting to store new CCM information into the table, the new CCM information is not stored into the table. In some embodiments, if a table has reached its maximum size when attempting to store new CCM information into the table, the CCM information stored earliest is deleted to free up space in the table.

In some embodiments, when the tables to store CCM information are picture-level tables, the maximum size limit for tables of intra frames are larger than the maximum size limit for tables of the inter frames. In some embodiments, tables associated with pictures with larger temporal id have smaller maximum size limit. In some embodiments, for random access configuration, the CCM information from pictures in the largest temporal id layer is not stored. Hence the sizes of tables are 0 (i.e., those tables and the associated index buffers are not created). In some embodiment, the maximum size limit of a table is related to the POC distance between the associated picture with and the closest intra frame of the associated picture (in terms of POC distance) that's previously coded. The shorter the POC distance is, the larger the maximum size limit is.

In some embodiments, when one table is created for each temporal id, CCM information from the layer with the same temporal id is stored in the same table. The table associated with larger temporal id has smaller maximum size limit. In some embodiments, for random access configuration, the CCM information from pictures in the largest temporal id layer is not stored. Hence the size of the table is 0 (i.e., the table and the associated index buffer are not created). In some embodiments, the maximum size limit of a table is related to the POC distance between the associated picture and the closest intra frame of the associated picture (in terms of POC distance) that's previously coded. The shorter the POC distance is, the larger the maximum size limit is.

In some embodiments, when several tables are used to store CCM information from one picture, a picture can be divided into several regions, with each region corresponding to its own table. The tables can have different maximum size limits or can have the same maximum size limit. In some embodiments, the tables associated with pictures with larger temporal id have smaller maximum size limit. In some embodiments, the maximum size limit of a table is related to the POC distance between the associated picture and the closest intra frame of the associated picture (in terms of POC distance) that is previously coded. The shorter the POC distance is, the larger the maximum size limit is.

In some embodiments, when attempting to store CCM information at position (x, y) of the picture into the table, the similarity between the to-be-added CCM information and the existing CCM information in the table can be compared. If the to-be-added CCM information is similar to an existing CCM information, the to-be-added CCM information will not be stored, and the index of that existing CCM information is stored at the position (x, y) in the index buffer. The similarity between CCM information can be determined through methods the same as methods used to compare models when adding models into a history table, as described in Section V.j. In some embodiments, the similarity between CCM information can be determined through methods similar to those of comparing models when adding models into the merge candidate list, as described above in Section V.i.

In some embodiments, the table can be reset at the beginning of encoding/decoding of an Instantaneous Decoder Refresh (IDR) picture. In some embodiments, the table can be reset after encoding/decoding of an IDR picture. In some embodiments, the table can be reset at the beginning of encoding/decoding of a Clear Random Access (CRA) picture. In some embodiments, the table can be reset after encoding/decoding of a CRA picture. In some embodiments, the reset mechanism can be the same as that used in parameter set or reference pictures.

In some embodiments, indices stored in the index buffer can only be referenced by a unit larger than or equal to the smallest coding unit. For example, if the smallest coding unit is 4×4, the indexes can be reference by an 8×8 grid. That is, one 8×8 block has the same index value. To retrieve index value at position (x, y), the position (x, y) can be rounded to a point on the grid (e.g., (x>>3)<<3, (y>>3)<<3) or to its nearest point on the grid.

In some embodiments, the CCM information to be stored in the table can be explicitly signaled in the bitstream in SPS, PPS, PH or SH. The corresponding positions of the CCM information can also be signaled.

i. Remove or Modify Similar Neighboring Model Parameters

When inheriting cross-component model parameters from other blocks, the video coder may further check the similarity between the inherited model and the existing models in the candidate list or those model candidates derived by the neighboring reconstruction samples of the current block (e.g., models derived by CCLM, MMLM, or CCCM using the neighboring reconstruction samples of the current block). If the model of a candidate parameter is similar to the existing models, the model would not be included into the candidate list.

In some embodiments, when comparing two models, if their cross-component coding modes (e.g., CCLM, MMLM, CCCM, CCCM with multiple models, GLM, CCRM, . . . ) are not the same, these two models are not similar. In some embodiments, when comparing one model with existing models in the candidate list, if the coding modes are the same and all the corresponding parameters of the two models are the same or similar, these two models are similar, and the model is not added into the candidate list. In some embodiments, if the difference between two parameters is less than or equal to a threshold, these two parameters are considered similar.

In some embodiments, if the model of a candidate is similar to one of existing candidate models, the video coder may adjust the inherited model parameters to make the inherited model be different from the existing candidate models. For example, if the inherited scaling parameter is similar to one of existing candidate models, the inherited scaling parameter may add a predefined offset (e.g., 1>>S or −(1>>S), where S is the shift parameter) to make the inherited parameter be different from the existing candidate models.

In some embodiments, the video coder may compare only partial model parameters (of the to-be-added model) with the existing models in the candidate list. For example, when a to-be-added CCLM candidate model has scale and offset parameters, the video coder may determine only whether the scale or offset parameters is the same or similar with existing candidates or not. If the scale or offset parameters of a to-be-added model and the existing model are the same or similar, the new candidate would not be included into the candidate list. For another example, when a to-be-added CCCM candidate has c0 to c6 parameters, the video coder may determine only whether n parameters (n<7) are the same or similar with existing candidates or not. If all the to-be-compared parameters are the same or similar, the to-be-added candidate model would not be included into the candidate list.

In some embodiments, the number of candidates with the same type (e.g., MMLM, CCCM, or GLM) is limited when including the candidates into the list. For example, if the current list has k candidates with MMLM type, the video coder does not further include candidates with MMLM type into the list. For another example, if the current list has k candidates with CCCM type, the video coder does not further include candidates with CCCM type into the list. For another example, if the current list has k candidates with GLM type, the video coder does not further include candidates with GLM type into the list.

j. Remove or Modify Similar Model Parameters when Adding Candidate to History Table

When adding cross-component model into a history table, the video coder may further check the similarity between the to-be-added model and the existing models in the history table. If the to-be-added model is similar with the existing models, the to-be-added model would not be included into the history table.

In some embodiments, if the to-be-added, inherited model is similar to one of existing candidate models, the video coder may adjust the inherited model parameters to make the to-be-added model be different from the existing candidate models. For example, if the scaling parameter of the to-be-added model is similar to one of existing candidate models, the video coder may add a predefined offset to the scaling parameter of the to-be-added model (e.g., 1>>S or −(1>>S), where S is the shift parameter) to make the to-be-added model be different from the existing candidate models.

In some embodiments, the video coder may compare only partial model parameters with the existing models in the history table. For example, a CCLM candidate has scale and offset parameters, the video coder may determine only whether the scale or offset parameters is the same or similar with existing candidates or not. If the scale or offset parameters of the to-be-added model and the existing model are the same or similar, the to-be-added model would not be included into the history table. For another example, a CCCM candidate has c0 to c6 parameters, the video coder may determine only whether n parameters (n<7) are the same or similar with existing candidates or not. If all the to-be-compared parameters are the same or similar, the to-be-added model would not be included into the history table.

In some embodiments, the number of candidates has the same type (e.g., MMLM, CCCM, or GLM) is limited when including the candidates into the history table. For example, if the current history table has k candidates with MMLM type, it is not allowed to further include candidates with MMLM type into the history table. For another example, if the current history table has k candidates with CCCM type, it is not allowed to further include candidates with CCCM type into the history table. For another example, if the current history table has k candidates with GLM type, it is not allowed to further include candidates with GLM type into the history table.

In some embodiments, the constraints, or rules to prevent adding a redundant candidate into a history table would share/be the same as that of preventing to add a redundant candidate into a candidate list. Examples of such rules or constraints can be found in Section V.i “Remove or modify similar neighboring model parameters”.

k. Reorder the Candidate List

The candidates in the list can be reordered to reduce the syntax overhead when signaling the selected candidate index or to bypass the syntax for signaling the selected candidate index by using implicit rule to select the one or more candidates.

In some embodiments, the reordering rules can depend on the coding information of neighboring blocks or the model error. For example, if neighboring above or left blocks are coded by MMLM, the MMLM candidates in the list can be moved to the head of the current list.

In some embodiments, the reordering rule is based on the model error by applying the candidate model to the neighboring templates of the current block, and then compare the error with the reconstruction samples of the neighboring template.

### L. Self-Derived Cross-Component Model

A self-derived cross-component model is one whose model parameters are derived from the current chroma samples and collocated luma samples (for example, motion compensation results if the current block is inter). An example of the self-derived cross-component model is CCRM. In some embodiments, when using self-derivation to generate a cross-component model, the model (filtering shape/pattern, parameter terms) is unified with the model in regular intra. For example, CCRM model can be unified with any pre-defined existing intra cross-component model (e.g., CCCM using non-down-sampled luma samples, GLM, MMLM).

In some embodiments, the self-derived cross-component candidate refers to one or more models that are used to generate the cross-component prediction of the current block. The cross-component prediction (used for generating target predicted samples) of the current bock is formed by combining one or more source terms according to a weighting setting according to the following:

$$pred ( i , j ) = ( sourceTermSet 0 ( i , j ) + sourceTermSet 1 ( i , j ) + … + biasTermSet ) \qquad ( 1 )$$

with the proposed weighting setting where (i, j) is a sample position in the current block.

As shown in the Eq. (1) above, pred(i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Eq. (1) is an example and the proposed mechanism may use any subset or extension of sourceTermSet0, sourceTermSet1, and biasTermSet. Each sample or any subset of samples in the current block gets its target (predicted) sample according to the Eq. (1). The content of sourceTermSet0(i,j), sourceTermSet1(i, j)”, biasTermSet are described below.

SourceTermSet0(i, j) includes one or more luma source terms denoted as sourceTerm00, sourceTerm01, . . . , and/or sourceTerm0n−1. The value of n means the number of taps for the source term set. In some embodiments, the source terms can be linear terms and/or non-linear terms, only linear terms, and/or only non-linear terms.

In some embodiments, n is a pre-defined value such as 1, 2, . . . or any positive integer. For example, the pre-defined value is fixed in the standard. In some embodiments, n is determined by coding information of the current block and/or sample position (i, j). For example, when the current block is coded by a specific coding tool, n can be fixed at a pre-defined value for that specific coding tool.

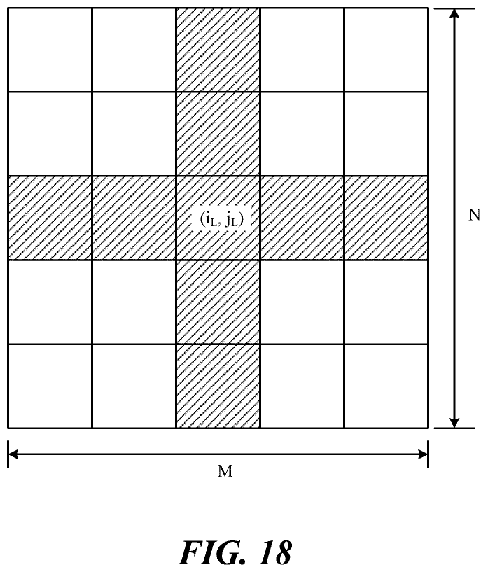

In some embodiments, the pattern of the n taps refers to a pattern defined as any subset of a window region M×N around/including the position (i_{L}, j_{L}). FIG. 18 illustrates an example pattern of n taps in a window region M×N. If the target sample is luma, (i_{L}, j_{L}) is (i, j). The figure illustrates the pattern being 5×5 cross: (including or not excluding (i_{L}, j_{L})). If the target sample is chroma (e.g., Cb or Cr), (i_{L}, j_{L}) is the collocated luma position from (i, j). For one example, only the center (i_{L}, j_{L}) of the window is used.

In some embodiments, the source content is based on a predicted sample generated by a prediction mode and/or a reconstructed sample generated based on the predicted sample by a prediction mode and a reconstructed residual. In some embodiments, the source content is the filtered source or the source with any pre-processing. For example, the source content is the predicted/reconstructed sample after filtering with a pre-defined model or filter.

In some embodiments, the source content is gradient information from the predicted samples and/or reconstructed samples. If the target sample (i, j) belongs to chroma and gradient information of the collocated luma sample (as the center circle) is calculated with a Sobel Filter or a pre-defined filter. FIG. 1 above illustrates several different example Sobel filters. In each of the example Sobel filters, each value around the center circle is multiplied with the corresponding predicted/reconstructed samples in the collocated luma block and then added with each other to form the gradient information for the source term of the target sample (i, j).

In some embodiments, since the target sample belongs to a chroma sample (e.g., Cb or Cr)), the predicted sample and/or the reconstructed sample is located within the collocated (luma) block from the current (chroma) block. The predicted sample and/or the reconstructed sample is treated as an initial sample and used as source content to generate the target sample. In some embodiments, the source term may further include location information. For example, if the target sample refers to luma, the horizontal location (i) of (i, j) is used in a source term and the vertical location (j) of (i, j) is used in a source term. Otherwise, the horizontal location of the collocated luma block from the sample (i, j) is used in a source term and the vertical location of the collocated luma block from the sample (i, j) is used in a source term.

In some embodiments, the source term may further include location information. For example, if the target sample refers to chroma, the horizontal location of the collocated luma from the sample (i, j) is used in a source term, and the vertical location of the collocated luma from the sample (i, j) is used in a source term.

SourceTermSet1(i, j) includes one or more chroma (Cb or Cr) source terms denoted as sourceTerm00, sourceTerm01, . . . , and/or sourceTerm0m−1. The value of m means the number of taps for the source term set. In some embodiments, the source terms can be linear terms and/or non-linear terms, only linear terms, and/or only non-linear terms. In another embodiment, m is a pre-defined value such as 1, 2, . . . or any positive integer. For example, the pre-defined value is fixed in the standard.

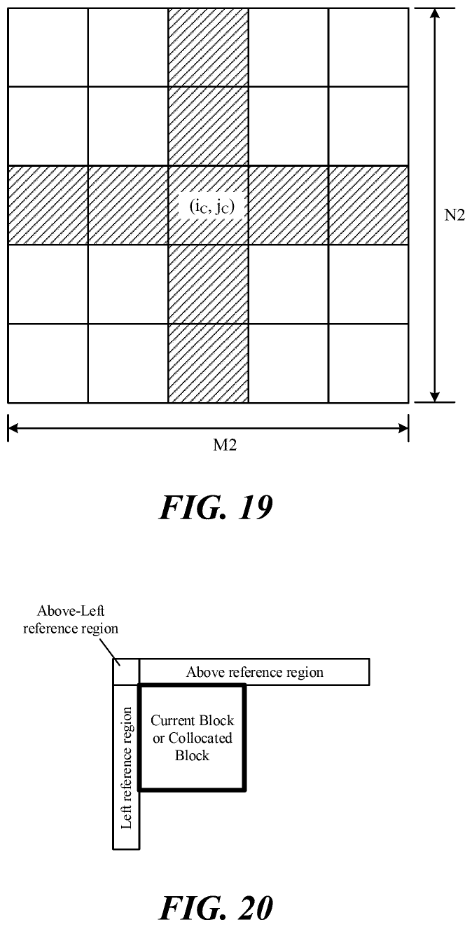

In some embodiments, m is determined by coding information of the current block and/or sample position (i, j). For example, when the current block is coded by a specific coding tool, m is fixed at a pre-defined value for that specific tool. In some embodiments, the pattern of the m taps refers to a pattern defined as any subset of a window region M2×N2 around/including the position (i_{C}, j_{C}). FIG. 19 illustrates an example pattern of n taps in a window region M2×N2 around the position (i_{C}, j_{C}). If the target sample is chroma (Cb or Cr), (i_{C},j_{C}) is (i, j). The figure illustrates an example in which the pattern is 5×5 cross (including or not excluding (i_{C},j_{C})). If the target sample is luma, (i_{C}, j_{C}) is the collocated chroma position from (i, j). For one example, only the center (i_{C},j_{C}) of the window is used.

In some embodiments, the source content is based on a predicted sample generated by a prediction mode and/or a reconstructed sample generated based on the predicted sample by a prediction mode and a reconstructed residual. In some embodiments, the source content is the filtered source or the source with any pre-processing. For example, the source content is the predicted/reconstructed sample after filtering with a pre-defined model or filter.

In some embodiments, the source content is gradient information from the predicted samples and/or reconstructed samples. If the target sample (i, j) belongs to luma and gradient information of the collocated chroma sample is calculated with any one of the Sobel filters (as illustrated in FIG. 1) or any pre-defined filter. In some embodiments, if the target sample belongs to a chroma sample, the predicted sample and/or the reconstructed sample is located within the current block. The predicted sample and/or the reconstructed sample is treated as an initial sample and used as source content to generate the target sample. In some embodiments, the source term may further include location information. For example, if the target sample refers to chroma, the horizontal location (i) of (i, j) is used in a source term and the vertical location (j) of (i, j) is used in a source term.

BiasTermSet is a pre-defined value. In one embodiment, the bias term is a midValue according to bitDepth specified in the standard. For example, the bias term is set as (1<<(bitDepth−1)). In some embodiments, the bias term is the same for each sample in the current block. That is, the bias term is regardless of the position (i, j).

In some embodiments, a weighting setting is used to (i) estimate the relationship (e.g., minimize the distortion) between the predicted and/or reconstructed samples on the reference region of the current (chroma) block and the predicted and/or reconstructed samples on the reference region of the corresponding luma block by a pre-defined regression method, (ii) to generate a weighting (referring to model parameters) according the regression method, and then (iii) to apply the weighting on the source terms to get the target (predicted) samples in the current block.

In some embodiments, the pre-defined regression method can be linear minimum mean square error (LMMSE) method as CCLM or can be any unified method with the regression method used for CCLM. In some embodiments, the pre-defined regression method can be the LDL decomposition method as CCCM or can be any unified method with the regression method used for CCCM. In some embodiments, the pre-defined regression method can be Gaussian elimination.

In some embodiments, the reference region of the current block is the spatial neighboring region of the current block. The reference region of the corresponding luma block is the spatial neighboring region of the corresponding luma block. FIG. 20 illustrates the spatial neighboring region of a current block 2000 that may serve as the reference region. As illustrated, the spatial neighboring region of the current block includes above reference region, left reference region, above-left reference region, and/or any subset of the above. The size of the above reference region is A_{W}×A_{H}, the size of the left reference region is L_{W}×L_{H}, and the size of the above-left reference is AL_{W}×AL_{H}, where
A_{W}=block width of the current block (W), k*W, W+block height of the current block (H), any pre-defined value, or any adaptive value depending on the block position, block width, block height, and/or block area of the current block.
A_{H} or AL_{H}=H, any pre-defined value (1, 2, 4, . . . ), or any adaptive value depending on the block position, block width, block height, and/or block area of the current block.
L_{W} or AL_{W}=W, any pre-defined value (1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

In some embodiments, the reference region of the current block is the vector-collocated region of the current block and the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information (motion vectors and reference pictures) of the corresponding luma block. For IBC or intraTMP, the vector-collocated region of the current block refers to the motion compensated results generated based on the motion information (block vectors and current picture) of the current block, and the vector-collocated region of the corresponding luma block refers to the motion compensated results generated based on the motion information (block vectors and current picture) of the corresponding luma block.

In some embodiments, the above-proposed two kinds of the reference region of the current block can be used together. For example, generally, samples in the vector-collocated region of the current block are used as input samples when deriving model parameters; however, for a smaller block, samples in the spatial neighboring reference region are used as additional input samples when deriving model parameters.

The term “block” in this invention can refer to TU/TB, CU/CB, PU/PB, or CTU/CTB. The term “LM” in this invention can be viewed as one kind of CCLM/MMLM modes or any other extension/variation of CCLM (e.g. the proposed CCLM extension/variation in this invention). One variation is MMLM which uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes. Any combination of the proposed methods in this invention can be applied. Any of the foregoing proposed methods can be implemented in encoders and/or decoders. For example, any of the proposed methods can be implemented in an inter/intra/prediction/IBC/transform/quantization module of an encoder, and/or an inter/intra/prediction/IBC/transform/quantization module of a decoder. Alternatively, any of the proposed methods can be implemented as a circuit coupled to the inter/intra/prediction/transform/quantization module of the encoder and/or the inter/intra/prediction/IBC/transform/quantization module of the decoder, so as to provide the information needed by the inter/intra/prediction/IBC/transform/quantization module.

### VI. Example Video Encoder

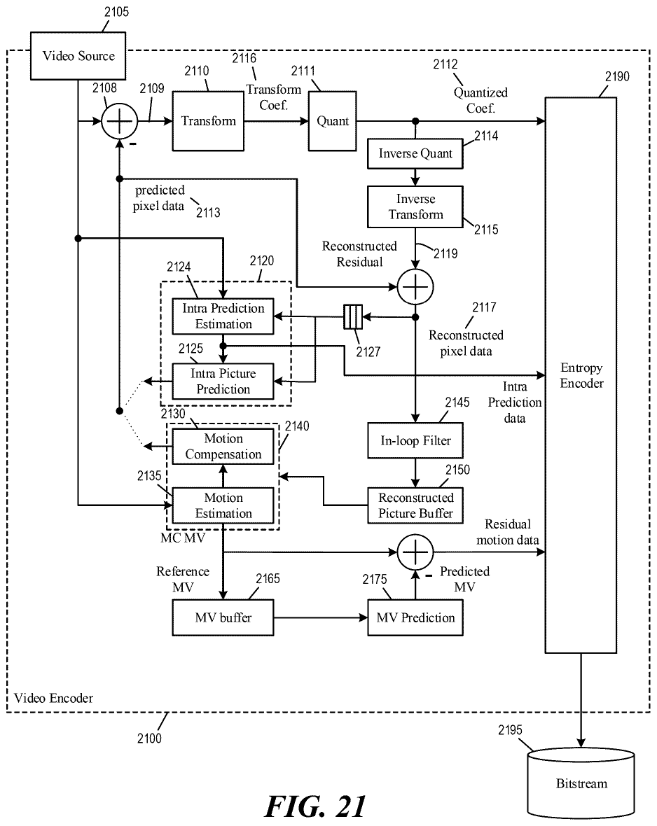

FIG. 21 illustrates an example video encoder 2100 that may implement cross-component prediction. As illustrated, the video encoder 2100 receives input video signal from a video source 2105 and encodes the signal into bitstream 2195. The video encoder 2100 has several components or modules for encoding the signal from the video source 2105, at least including some components selected from a transform module 2110, a quantization module 2111, an inverse quantization module 2114, an inverse transform module 2115, an intra-picture estimation module 2124, an intra-prediction module 2125, a motion compensation module 2130, a motion estimation module 2135, an in-loop filter 2145, a reconstructed picture buffer 2150, a MV buffer 2165, and a MV prediction module 2175, and an entropy encoder 2190. The motion compensation module 2130 and the motion estimation module 2135 are part of an inter-prediction module 2140. The intra-prediction module 2125 and the intra-prediction estimation module 2124 are part of a current picture prediction module 2120, which uses current picture reconstructed samples as reference samples for prediction of the current block.

In some embodiments, the modules 2110-2190 are modules of software instructions being executed by one or more processing units (e.g., a processor) of a computing device or electronic apparatus. In some embodiments, the modules 2110-2190 are modules of hardware circuits implemented by one or more integrated circuits (ICs) of an electronic apparatus. Though the modules 2110-2190 are illustrated as being separate modules, some of the modules can be combined into a single module.

The video source 2105 provides a raw video signal that presents pixel data of each video frame without compression. A subtractor 2108 computes the difference between the raw video pixel data of the video source 2105 and the predicted pixel data 2113 from the motion compensation module 2130 or intra-prediction module 2125 as prediction residual 2109. The transform module 2110 converts the difference (or the residual pixel data or residual signal 2108) into transform coefficients (e.g., by performing Discrete Cosine Transform, or DCT). The quantization module 2111 quantizes the transform coefficients into quantized data (or quantized coefficients) 2112, which is encoded into the bitstream 2195 by the entropy encoder 2190.

The inverse quantization module 2114 de-quantizes the quantized data (or quantized coefficients) 2112 to obtain transform coefficients, and the inverse transform module 2115 performs inverse transform on the transform coefficients to produce reconstructed residual 2119. The reconstructed residual 2119 is added with the predicted pixel data 2113 to produce reconstructed pixel data 2117. In some embodiments, the reconstructed pixel data 2117 is temporarily stored in a line buffer 2127 (or intra prediction buffer) for intra-picture prediction and spatial MV prediction. The reconstructed pixels are filtered by the in-loop filter 2145 and stored in the reconstructed picture buffer 2150. In some embodiments, the reconstructed picture buffer 2150 is a storage external to the video encoder 2100. In some embodiments, the reconstructed picture buffer 2150 is a storage internal to the video encoder 2100.

The intra-picture estimation module 2124 performs intra-prediction based on the reconstructed pixel data 2117 to produce intra prediction data. The intra-prediction data is provided to the entropy encoder 2190 to be encoded into bitstream 2195. The intra-prediction data is also used by the intra-prediction module 2125 to produce the predicted pixel data 2113.

The motion estimation module 2135 performs inter-prediction by producing MVs to reference pixel data of previously decoded frames stored in the reconstructed picture buffer 2150. These MVs are provided to the motion compensation module 2130 to produce predicted pixel data.

Instead of encoding the complete actual MVs in the bitstream, the video encoder 2100 uses MV prediction to generate predicted MVs, and the difference between the MVs used for motion compensation and the predicted MVs is encoded as residual motion data and stored in the bitstream 2195.

The MV prediction module 2175 generates the predicted MVs based on reference MVs that were generated for encoding previously video frames, i.e., the motion compensation MVs that were used to perform motion compensation. The MV prediction module 2175 retrieves reference MVs from previous video frames from the MV buffer 2165. The video encoder 2100 stores the MVs generated for the current video frame in the MV buffer 2165 as reference MVs for generating predicted MVs.

The MV prediction module 2175 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 2195 by the entropy encoder 2190.

The entropy encoder 2190 encodes various parameters and data into the bitstream 2195 by using entropy-coding techniques such as context-adaptive binary arithmetic coding (CABAC) or Huffman encoding. The entropy encoder 2190 encodes various header elements, flags, along with the quantized transform coefficients 2112, and the residual motion data as syntax elements into the bitstream 2195. The bitstream 2195 is in turn stored in a storage device or transmitted to a decoder over a communications medium such as a network.

The in-loop filter 2145 performs filtering or smoothing operations on the reconstructed pixel data 2117 to reduce the artifacts of coding, particularly at boundaries of pixel blocks. In some embodiments, the filtering or smoothing operations performed by the in-loop filter 2145 include deblock filter (DBF), sample adaptive offset (SAO), and/or adaptive loop filter (ALF). In some embodiments, luma mapping chroma scaling (LMCS) is performed before the loop filters.

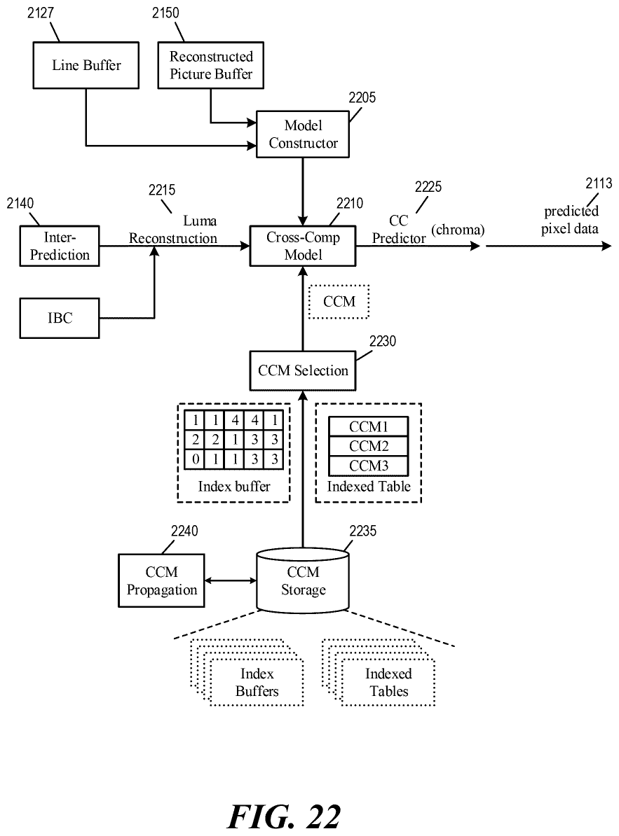

FIG. 22 illustrates portions of the video encoder 2100 that implement cross-component prediction for non-intra coded blocks. The luma component of the current block may be coded by inter-prediction (inter prediction module 2140) or current picture referencing (e.g., IBC) to generate a reconstruction 2215 for the luma component. A cross-component model 2210 is applied to the luma reconstruction 2215 to generate a cross-component predictor 2225 for a chroma component. The cross-component predictor 2225 is included in the predicted pixel data 2113.

The cross-component model 2210 may be generated by a model constructor 2205 based on samples (in and/or around the current block and/or a reference block) retrieved from the reconstructed picture buffer 2150 and/or the line buffer 2127, such as when the re-derived cross-component model is to be used for the current block. Section I above describe several types of cross-component models that may be used as the cross-component model 2210.

The cross-component model 2210 may also be provided by a CCM selection module 2230, which selects a cross-component model (CCM) information or other cross-component prediction (CCP) information that are inherited from one of a plurality of candidates as a merge mode. Merge mode for cross-component prediction is described in Section V above.

A CCM storage 2235 stores CCM information and corresponding support data structures. The CCM storage 2235 represents (or is implemented by) any form of storage that is used to store CCM information which includes cross-component models generated by the model constructor 2205. The CCM storage 2235 may store index buffers and indexed tables associated with different pictures, or different picture regions, or different temporal IDs. The stored CCM information and/or CCP information are made available to be inherited by subsequent blocks as merge mode candidates.

Each indexed table (may also be referred to as CCM table) has a corresponding index buffer for mapping a position in a picture to a location in the indexed table. To retrieve CCM information and/or CCP information for a selected CCP merge mode candidate, the encoder identifies the CCM table and the corresponding index buffer for the selected merge candidate (based on picture, temporal ID or region in a picture), then uses the candidate's position in the picture to look up an index in the identified index buffer. The index is in turn used to access the selected CCM information and/or CCP information in the CCM table.

A CCM propagation module 2240 operates to propagate CCM information between blocks and/or between pictures. For a position or current block that does not have CCM information and/or CCP information, the CCM propagation module 2240 may follow the current block's BV or MV to locate the CCM/CCP information of the reference block. The CCM propagation module 2240 may then propagate the CCM/CCP information by copying the CCM information of the reference block to the current block. The CCM/CCP information of the reference block may need to be accessed through the index buffers and CCM tables stored in the CCM storage 2235. The CCM propagation module 2240 may then propagate the CCM/CCP information by copying an index value in an index buffer from one position to another position in a same index buffer, or by copying CCM/CCP information from one CCM table to another CCM table.

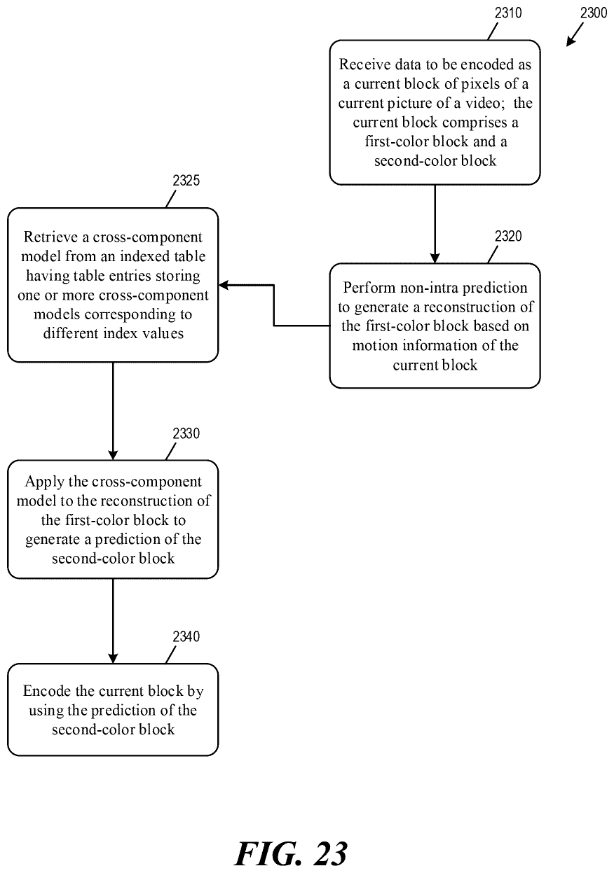

FIG. 23 conceptually illustrates a process 2300 for encoding a non-intra coded block by using cross-component prediction. In some embodiments, one or more processing units (e.g., a processor) of a computing device implementing the encoder 2100 performs the process 2300 by executing instructions stored in a computer readable medium. In some embodiments, an electronic apparatus implementing the encoder 2100 performs the process 2300.

The encoder receives (at block 2310) data to be encoded as a current block of pixels in a current picture. The current block having a first-color block and a second-color block. In some embodiment, the first-color block is for a luma component and the second-color block is for a chroma component. In some embodiments, the first-color block is for a first chroma component (e.g., Cb) and the second-color block is for a second chroma component (e.g., Cr).

The encoder performs (at block 2320) non-intra prediction to generate a reconstruction of the first-color block based on motion information of the current block. (Non-intra prediction may refer to inter-prediction or current picture referencing such as IBC.) The cross-component model may be inherited from a temporal candidate in a list of candidates that includes spatial candidates, non-adjacent candidates, temporal candidates, and/or historical candidates, etc. In some embodiments, the cross-component model may be propagated to a reference block from a further reference block that is located by the motion information of the reference block. The motion vector may locate a position in a collocated coding tree unit (CTU) row in a further reference picture of a CTU row in which the reference block is or the motion vector is clipped to locate a position in the collocated CTU row.

The encoder retrieves (at block 2325) a cross-component model from an indexed table having table entries storing one or more cross-component models corresponding to different index values.

In some embodiments, a position in a picture is used to lookup an index value in an index buffer having buffer entries storing index values corresponding to different positions of the picture, and the index value is used to retrieve the cross-component model. Indexed table and index buffer are described in Section IV.h. In some embodiments, the indexed table stores cross component models for all pictures of the video. In some embodiments, the indexed table is a picture-level table. In some embodiments, the indexed table is associated with one region of a plurality of regions of a picture. In some embodiments, the indexed table is associated with a temporal identifier layer that includes the current picture. In some embodiments (e.g., for random access configuration), no indexed table is created for pictures in a temporal identifier layer of a largest temporal identifier. In some embodiments, all pictures are in a same temporal identifier layer and all pictures are in the layer with the largest temporal layer.

In some embodiments, a buffer entry of the index buffer stores a default index value to indicate that no cross-component model is available for a corresponding position in the picture (in the examples of FIG. 14-17 the default index value is ‘0’). When a cross-component model is deleted from the indexed table, each buffer entry of the index buffer having an index value that indicates the deleted cross-component model is reset to the default index value, and each index value in the index buffer that is greater than the index value that indicates the deleted cross-component model is decreased by one. When a cross-component model is to be added to the indexed table for a position in a picture, if the to-be-added cross-component model is sufficiently similar to an existing cross-component model already stored in the indexed table, the to-be-added cross-component model is not added to the indexed table and an index value used to indicate the existing cross-component model is stored in a buffer entry of the index buffer that correspond to the position.

In some embodiments, the indexed table has a maximum size. In some embodiments, when the indexed table reaches a maximum size limit upon storing a new cross-component model into the indexed table, an earliest stored cross-component model is deleted from the indexed table to free up space for the new cross-component model. In some embodiments, when the indexed table reaches a maximum size limit upon storing a new cross-component model into the indexed table, the new cross-component model is not stored in the indexed table. The maximum size limit may be determined based on whether the picture is an inter frame or an intra frame, or based on a temporal identifier of the picture (e.g., a picture with a larger temporal id has smaller maximum size limit for its indexed table than that of a picture with a smaller temporal id), or based on a picture order count (POC) distance between the picture and a closest previously coded intra frame.

In some embodiments, when no cross-component model is available for the first position in the first indexed table, a cross-component model is copied from a second indexed table associated with a reference picture to the first indexed table (the reference picture may be located by the motion information), or a block vector is used to locate a second position in the picture and an index value is copied from a buffer entry for the second position to a buffer entry for the first position. In some embodiments, the indexed table is reset when the encoder is encoding an Instantaneous Decoding Refresh (IDR) or Clear Random Access (CRA) picture.

The encoder applies (at block 2330) the cross-component model to the reconstruction of the first-color block to generate a prediction of the second-color block. The encoder encodes (at block 2340) the current block by using the prediction of the second-color block to produce prediction residuals.

### VII. Example Video Decoder

In some embodiments, an encoder may signal (or generate) one or more syntax element in a bitstream, such that a decoder may parse said one or more syntax element from the bitstream.

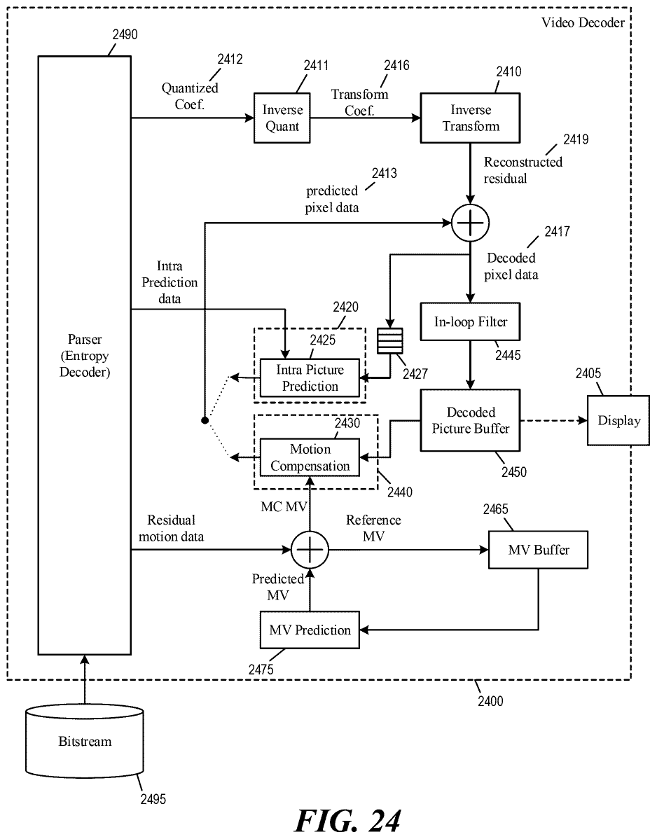

FIG. 24 illustrates an example video decoder 2400 that may implement cross-component prediction. As illustrated, the video decoder 2400 is an image-decoding or video-decoding circuit that receives a bitstream 2495 and decodes the content of the bitstream into pixel data of video frames for display. The video decoder 2400 has several components or modules for decoding the bitstream 2495, including some components selected from an inverse quantization module 2411, an inverse transform module 2410, an intra-prediction module 2425, a motion compensation module 2430, an in-loop filter 2445, a decoded picture buffer 2450, a MV buffer 2465, a MV prediction module 2475, and a parser 2490. The motion compensation module 2430 is part of an inter-prediction module 2440. The intra-prediction module 2425 is part of a current picture prediction module 2420, which uses current picture reconstructed samples as reference samples for prediction of the current block.

In some embodiments, the modules 2410-2490 are modules of software instructions being executed by one or more processing units (e.g., a processor) of a computing device. In some embodiments, the modules 2410-2490 are modules of hardware circuits implemented by one or more ICs of an electronic apparatus. Though the modules 2410-2490 are illustrated as being separate modules, some of the modules can be combined into a single module.

The parser 2490 (or entropy decoder) receives the bitstream 2495 and performs initial parsing according to the syntax defined by a video-coding or image-coding standard. The parsed syntax element includes various header elements, flags, as well as quantized data (or quantized coefficients) 2412. The parser 2490 parses out the various syntax elements by using entropy-coding techniques such as context-adaptive binary arithmetic coding (CABAC) or Huffman encoding.

The inverse quantization module 2411 de-quantizes the quantized data (or quantized coefficients) 2412 to obtain transform coefficients, and the inverse transform module 2410 performs inverse transform on the transform coefficients 2416 to produce reconstructed residual signal 2419. The reconstructed residual signal 2419 is added with predicted pixel data 2413 from the intra-prediction module 2425 or the motion compensation module 2430 to produce decoded pixel data 2417. The decoded pixels data are filtered by the in-loop filter 2445 and stored in the decoded picture buffer 2450. In some embodiments, the decoded picture buffer 2450 is a storage external to the video decoder 2400. In some embodiments, the decoded picture buffer 2450 is a storage internal to the video decoder 2400.

The intra-prediction module 2425 receives intra-prediction data from bitstream 2495 and according to which, produces the predicted pixel data 2413 from the decoded pixel data 2417 stored in the decoded picture buffer 2450. In some embodiments, the decoded pixel data 2417 is also stored in a line buffer 2427 (or intra prediction buffer) for intra-picture prediction and spatial MV prediction.

In some embodiments, the content of the decoded picture buffer 2450 is used for display. A display device 2405 either retrieves the content of the decoded picture buffer 2450 for display directly, or retrieves the content of the decoded picture buffer to a display buffer. In some embodiments, the display device receives pixel values from the decoded picture buffer 2450 through a pixel transport.

The motion compensation module 2430 produces predicted pixel data 2413 from the decoded pixel data 2417 stored in the decoded picture buffer 2450 according to motion compensation MVs (MC MVs). These motion compensation MVs are decoded by adding the residual motion data received from the bitstream 2495 with predicted MVs received from the MV prediction module 2475.

The MV prediction module 2475 generates the predicted MVs based on reference MVs that were generated for decoding previous video frames, e.g., the motion compensation MVs that were used to perform motion compensation. The MV prediction module 2475 retrieves the reference MVs of previous video frames from the MV buffer 2465. The video decoder 2400 stores the motion compensation MVs generated for decoding the current video frame in the MV buffer 2465 as reference MVs for producing predicted MVs.

The in-loop filter 2445 performs filtering or smoothing operations on the decoded pixel data 2417 to reduce the artifacts of coding, particularly at boundaries of pixel blocks. In some embodiments, the filtering or smoothing operations performed by the in-loop filter 2445 include deblock filter (DBF), sample adaptive offset (SAO), and/or adaptive loop filter (ALF). In some embodiments, luma mapping chroma scaling (LMCS) is performed before the loop filters.

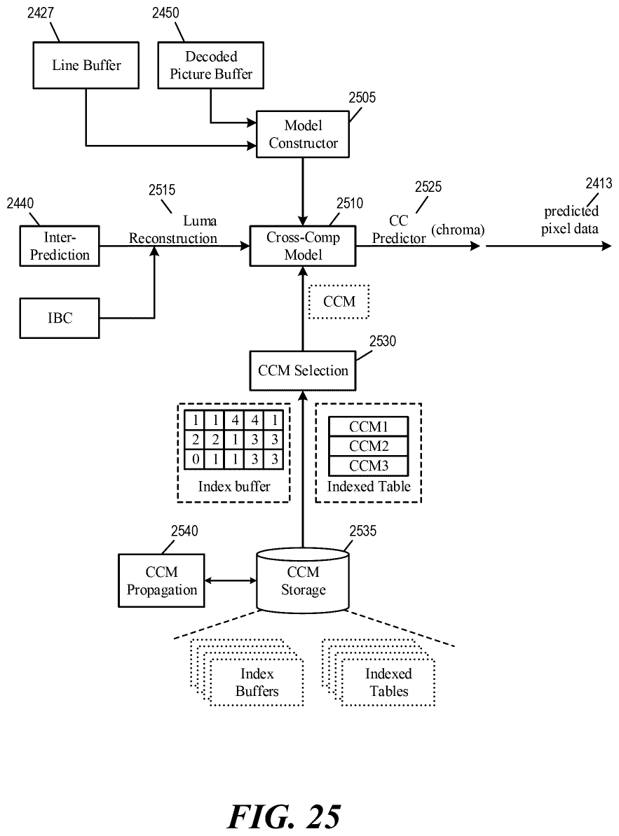

FIG. 25 illustrates portions of the video decoder 2400 that implement cross-component prediction for non-intra coded blocks. The luma component of the current block may be coded by inter-prediction (inter prediction module 2440) or current picture referencing (e.g., IBC) to generate a reconstruction 2515 for the luma component. A cross-component model 2510 is applied to the luma reconstruction 2515 to generate a cross-component predictor 2525 for a chroma component. The cross-component predictor 2525 is included in the predicted pixel data 2413.

The cross-component model 2510 may be generated by a model constructor 2505 based on samples (in and/or around the current block and/or a reference block) retrieved from the decoded picture buffer 2450 and/or the line buffer 2427. Section I above describe several types of cross-component models that may be used as the cross-component model 2510.

The cross-component model 2510 may also be provided by a CCM selection module 2530, which provide a cross-component model (CCM) information or other cross-component prediction (CCP) information that are inherited from one of a plurality of candidates as a merge mode. Merge mode for cross-component prediction is described in Section V above.

A CCM storage 2535 stores CCM information and corresponding support data structures. The CCM storage 2535 represents (or is implemented by) any form of storage that is used to store CCM information which includes cross-component models generated by the model constructor 2505. The CCM storage 2535 may store index buffers and indexed tables associated with different pictures, or different picture regions, or different temporal IDs. The stored CCM information and/or CCP information are made available to be inherited by subsequent blocks as merge mode candidates.

Each indexed table (may also be referred to as CCM table) has a corresponding index buffer for mapping a position in a picture to a location in the indexed table. To retrieve CCM information and/or CCP information for a selected CCP merge mode candidate, the decoder identifies the CCM table and the corresponding index buffer for the selected merge candidate (based on picture, temporal ID or region in a picture), then uses the candidate's position in the picture to look up an index in the identified index buffer. The index is in turn used to access the selected CCM information and/or CCP information in the CCM table.

A CCM propagation module 2540 operates to propagate CCM information between blocks and/or between pictures. For a position or current block that does not have CCM information and/or CCP information, the CCM propagation module 2540 may follow the current block's BV or MV to locate the CCM/CCP information of the reference block. The CCM propagation module 2540 may then propagate the CCM/CCP information by copying the CCM information of the reference block to the current block. The CCM/CCP information of the reference block may need to be accessed through the index buffers and CCM tables stored in the CCM storage 2535. The CCM propagation module 2540 may then propagate the CCM/CCP information by copying an index value in an index buffer from one position to another position in a same index buffer, or by copying CCM/CCP information from one CCM table to another CCM table.

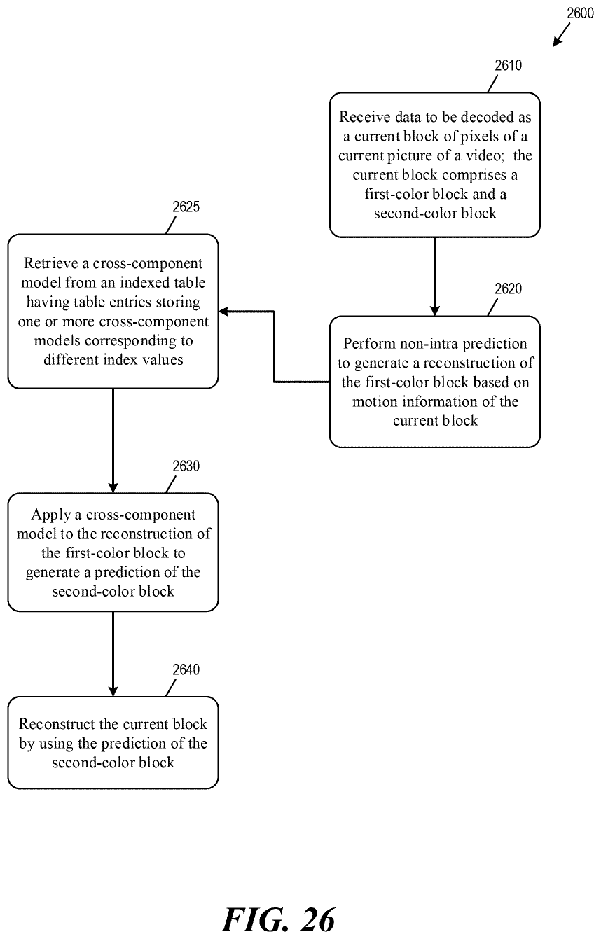

FIG. 26 conceptually illustrates a process 2600 for decoding an inter-coded block by using cross-component prediction. In some embodiments, one or more processing units (e.g., a processor) of a computing device implementing the decoder 2400 performs the process 2600 by executing instructions stored in a computer readable medium. In some embodiments, an electronic apparatus implementing the decoder 2400 performs the process 2600.

The decoder receives (at block 2610) data to be decoded as a current block of pixels in a current picture. The current block having a first-color block and a second-color block. In some embodiment, the first-color block is for a luma component and the second-color block is for a chroma component. In some embodiments, the first-color block is for a first chroma component (e.g., Cb) and the second-color block is for a second chroma component (e.g., Cr).

The decoder performs (at block 2620) non-intra prediction to generate a reconstruction of the first-color block based on motion information of the current block. (Non-intra prediction may refer to inter-prediction or current picture referencing such as IBC.) The cross-component model may be inherited from a temporal candidate in a list of candidates that includes spatial candidates, non-adjacent candidates, temporal candidates, and/or historical candidates, etc. In some embodiments, the cross-component model may be propagated to a reference block from a further reference block that is located by the motion information of the reference block. The motion vector may locate a position in a collocated coding tree unit (CTU) row in a further reference picture of a CTU row in which the reference block is or the motion vector is clipped to locate a position in the collocated CTU row.

The decoder retrieves (at block 2625) a cross-component model from an indexed table having table entries storing one or more cross-component models corresponding to different index values.

In some embodiments, a position in a picture is used to lookup an index value in an index buffer having buffer entries storing index values corresponding to different positions of the picture, and the index value is used to retrieve the cross-component model. Indexed table and index buffer are described in Section IV.h. In some embodiments, the indexed table stores cross component models for all pictures of the video. In some embodiments, the indexed table is a picture-level table. In some embodiments, the indexed table is associated with one region of a plurality of regions of a picture. In some embodiments, the index table is associated with a temporal identifier layer that includes the current picture. In some embodiments (e.g., for random access configuration), no indexed table is created for pictures in a temporal identifier layer of a largest temporal identifier. In some embodiments, all pictures are in a same temporal identifier layer and all pictures are in the layer with the largest temporal layer.

In some embodiments, a buffer entry of the index buffer stores a default index value to indicate that no cross-component model is available for a corresponding position in the picture (in the examples of FIGS. 14-17 the default index value is ‘0’). When a cross-component model is deleted from the indexed table, each buffer entry of the index buffer having an index value that indicates the deleted cross-component model is reset to the default index value, and each index value in the index buffer that is greater than the index value that indicates the deleted cross-component model is decreased by one. When a cross-component model is to be added to the indexed table for a position in a picture, if the to-be-added cross-component model is sufficiently similar to an existing cross-component model already stored in the indexed table, the to-be-added cross-component model is not added to the indexed table and an index value used to indicate the existing cross-component model is stored in a buffer entry of the index buffer that correspond to the position.

In some embodiments, the indexed table has a maximum size. In some embodiments, when the indexed table reaches a maximum size limit upon storing a new cross-component model into the indexed table, an earliest stored cross-component model is deleted from the indexed table to free up space for the new cross-component model. In some embodiments, when the indexed table reaches a maximum size limit upon storing a new cross-component model into the indexed table, the new cross-component model is not stored in the indexed table. The maximum size limit may be determined based on whether the picture is an inter frame or an intra frame, or based on a temporal identifier of the picture (e.g., a picture with a larger temporal id has smaller maximum size limit for its indexed table than that of a picture with a smaller temporal id), or based on a picture order count (POC) distance between the picture and a closest previously coded intra frame.

In some embodiments, when no cross-component model is available for the first position in the first indexed table, a cross-component model is copied from a second indexed table associated with a reference picture to the first indexed table (the reference picture may be located by the motion information), or a block vector is used to locate a second position in the picture and an index value is copied from a buffer entry for the second position to a buffer entry for the first position. In some embodiments, the indexed table is reset when the decoder is decoding an Instantaneous Decoding Refresh (IDR) or Clear Random Access (CRA) picture.

The decoder applies (at block 2630) a cross-component model to the reconstruction of the first-color block to generate a prediction of the second-color block. The decoder reconstructs (at block 2640) the current block by using the prediction of the second-color block and corresponding prediction residuals. The decoder may then provide the reconstructed current block for display as part of the reconstructed current picture.

### VIII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

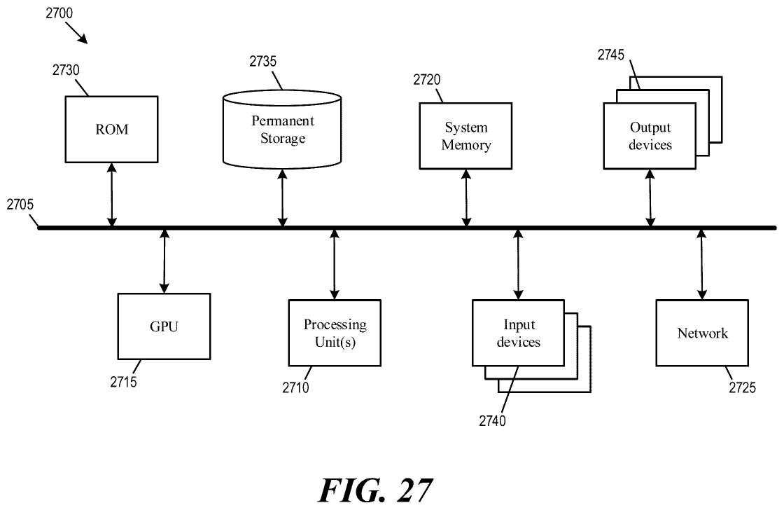

FIG. 27 conceptually illustrates an electronic system 2700 with which some embodiments of the present disclosure are implemented. The electronic system 2700 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2700 includes a bus 2705, processing unit(s) 2710, a graphics-processing unit (GPU) 2715, a system memory 2720, a network 2725, a read-only memory 2730, a permanent storage device 2735, input devices 2740, and output devices 2745.

The bus 2705 collectively represents all system, peripheral, and chipset buses that communicatively connect the numerous internal devices of the electronic system 2700. For instance, the bus 2705 communicatively connects the processing unit(s) 2710 with the GPU 2715, the read-only memory 2730, the system memory 2720, and the permanent storage device 2735.

From these various memory units, the processing unit(s) 2710 retrieves instructions to execute and data to process in order to execute the processes of the present disclosure. The processing unit(s) may be a single processor or a multi-core processor in different embodiments. Some instructions are passed to and executed by the GPU 2715. The GPU 2715 can offload various computations or complement the image processing provided by the processing unit(s) 2710.

The read-only-memory (ROM) 2730 stores static data and instructions that are used by the processing unit(s) 2710 and other modules of the electronic system. The permanent storage device 2735, on the other hand, is a read-and-write memory device. This device is a non-volatile memory unit that stores instructions and data even when the electronic system 2700 is off. Some embodiments of the present disclosure use a mass-storage device (such as a magnetic or optical disk and its corresponding disk drive) as the permanent storage device 2735.

Other embodiments use a removable storage device (such as a floppy disk, flash memory device, etc., and its corresponding disk drive) as the permanent storage device. Like the permanent storage device 2735, the system memory 2720 is a read-and-write memory device. However, unlike storage device 2735, the system memory 2720 is a volatile read-and-write memory, such a random access memory. The system memory 2720 stores some of the instructions and data that the processor uses at runtime. In some embodiments, processes in accordance with the present disclosure are stored in the system memory 2720, the permanent storage device 2735, and/or the read-only memory 2730. For example, the various memory units include instructions for processing multimedia clips in accordance with some embodiments. From these various memory units, the processing unit(s) 2710 retrieves instructions to execute and data to process in order to execute the processes of some embodiments.

The bus 2705 also connects to the input and output devices 2740 and 2745. The input devices 2740 enable the user to communicate information and select commands to the electronic system. The input devices 2740 include alphanumeric keyboards and pointing devices (also called “cursor control devices”), cameras (e.g., webcams), microphones or similar devices for receiving voice commands, etc. The output devices 2745 display images generated by the electronic system or otherwise output data. The output devices 2745 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 27, bus 2705 also couples electronic system 2700 to a network 2725 through a network adapter (not shown). In this manner, the computer can be a part of a network of computers (such as a local area network (“LAN”), a wide area network (“WAN”), or an Intranet, or a network of networks, such as the Internet. Any or all components of electronic system 2700 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 23 and FIG. 26) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video, wherein the current block comprises a first-color block and a second-color block;
performing a non-intra-prediction to generate a reconstruction of the first-color block based on motion information of the current block;
retrieving a cross-component model from an indexed table having table entries storing one or more cross-component models corresponding to different index values, wherein a position in a picture is used to lookup an index value in an index buffer having buffer entries storing index values corresponding to different positions of the picture;
applying the cross-component model to the reconstruction of the first-color block to generate a prediction of the second-color block; and
encoding or decoding the current block by using the prediction of the second-color block.

2. The video coding method of claim 1, wherein a buffer entry of the index buffer stores a default index value to indicate that no cross-component model is available for a corresponding position in the picture.

3. The video coding method of claim 2, wherein when a cross-component model is deleted from the indexed table, each buffer entry of the index buffer having an index value that indicates the deleted cross-component model is reset to the default index value.

4. The video coding method of claim 3, wherein each index value in the index buffer that is greater than the index value that indicates the deleted cross-component model is decreased by one.

5. The video coding method of claim 1, wherein
when a cross-component model is to be added to the indexed table for a position in a picture, if the to-be-added cross-component model is sufficiently similar to an existing cross-component model already stored in the indexed table, the to-be-added cross-component model is not added to the indexed table and an index value used to indicate the existing cross-component model is stored in a buffer entry of the index buffer that correspond to the position.

6. The video coding method of claim 1, wherein the cross-component model is propagated to a reference block from a further reference block that is located by the motion information of the reference block.

7. The video coding method of claim 6, wherein the motion information locates a position in a collocated coding tree unit (CTU) row in a further reference picture of a CTU row in which the reference block is or is clipped to locate a position in the collocated CTU row.

8. The video coding method of claim 1, wherein the cross-component model is inherited from a temporal candidate in a list of candidates that includes spatial candidates, non-adjacent candidates, temporal candidates, or historical candidates.

9. The video coding method of claim 1, wherein the indexed table is a picture-level table.

10. The video coding method of claim 1, wherein the indexed table stores cross component models for all pictures of the video.

11. The video coding method of claim 1, wherein the indexed table is associated with a temporal identifier layer that includes the current picture.

12. The video coding method of claim 1, wherein the indexed table is associated with one region of a plurality of regions of a picture.

13. The video coding method of claim 1, wherein the indexed table has a maximum size limit.

14. The video coding method of claim 13, wherein when the indexed table reaches the maximum size limit upon storing a new cross-component model into the indexed table, an earliest stored cross-component model is deleted from the indexed table to free up space for the new cross-component model.

15. The video coding method of claim 13, wherein when the indexed table reaches the maximum size limit upon storing a new cross-component model into the indexed table, the new cross-component model is not stored into the indexed table.

16. The video coding method of claim 13, wherein the maximum size limit is determined based on whether the picture is an inter frame or an intra frame.

17. The video coding method of claim 13, wherein the maximum size limit is determined based on a temporal identifier of the picture.

18. The video coding method of claim 17, wherein no indexed table is created for pictures in a temporal identifier layer of a largest temporal identifier.

19. The video coding method of claim 1, wherein the indexed table has a maximum size limit that is determined based on a picture order count (POC) distance between the picture and a closest previously coded intra frame.

20. The video coding method of claim 1, wherein when no cross-component model is available for the first position in the first indexed table, a cross-component model is copied from a second indexed table associated with a reference picture to the first indexed table, wherein the reference picture is located by the motion information.

21. The video coding method of claim 1, wherein when no cross-component model is available for the first position in the first indexed table, a block vector is used to locate a second position in the picture and an index value is copied from a buffer entry for the second position to a buffer entry for the first position.

22. The video coding method of claim 1, wherein the indexed table is reset when encoding or decoding an Instantaneous Decoding Refresh (IDR) or Clear Random Access (CRA) picture.

23. An electronic apparatus comprising:
a video coder circuit configured to perform operations comprising:
receiving data to be encoded or decoded as a current block of pixels of a current picture of a video, wherein the current block comprises a first-color block and a second-color block;
performing non-intra prediction to generate a reconstruction of the first-color block based on motion information of the current block;
retrieving a cross-component model from an indexed table having table entries storing one or more cross-component models corresponding to different index values, wherein a position in a picture is used to lookup an index value in an index buffer having buffer entries storing index values corresponding to different positions of the picture;
applying the cross-component model to the reconstruction of the first-color block to generate a prediction of the second-color block; and
encoding or decoding the current block by using the prediction of the second-color block.

24. A video decoding method comprising:
receiving data to be decoded as a current block of pixels of a current picture of a video, wherein the current block comprises a first-color block and a second-color block;
performing non-intra prediction to generate a reconstruction of the first-color block based on motion information of the current block;
retrieving a cross-component model from an indexed table having table entries storing one or more cross-component models corresponding to different index values, wherein a position in a picture is used to lookup an index value in an index buffer having buffer entries storing index values corresponding to different positions of the picture;
applying the cross-component model to the reconstruction of the first-color block to generate a prediction of the second-color block; and
reconstructing the current block by using the prediction of the second-color block.

25. A video encoding method comprising:
receiving data to be encoded as a current block of pixels of a current picture of a video, wherein the current block comprises a first-color block and a second-color block;
performing non-intra prediction to generate a reconstruction of the first-color block based on motion information of the current block;
retrieving a cross-component model from an indexed table having table entries storing one or more cross-component models corresponding to different index values, wherein a position in a picture is used to lookup an index value in an index buffer having buffer entries storing index values corresponding to different positions of the picture;
applying the cross-component model to the reconstruction of the first-color block to generate a prediction of the second-color block; and
encoding the current block by using the prediction of the second-color block.
